(19) United States
(12) Patent Application Publication
(10) Pub. No.: US 2006/0104218 A1
(43) Pub. Date: May 18, 2006

(54) System for analyzing quality of communication sections

(76) Inventor: Masaharu Kako, Osaka (JP)

Correspondence Address: KATTEN MUCHIN ROSENMAN LLP, 575 MADISON AVENUE, NEW YORK, NY, 10022-2585, US

(21) Appl. No.: 11/322,108

(22) Filed: Dec. 29, 2005

Related U.S. Application Data
(63) Continuation of application No. PCT/JP03/09934, filed on Aug. 5, 2003.

(51) Int. Cl. H04J 1/16

(52) U.S. Cl. 370/252

(57) ABSTRACT

A system for analyzing quality of communication sections includes a transmission device transmitting a test measurement signal, a reception device receiving the test measurement signal, relay devices each located on a transmission path of the test measurement signal between the transmission device and the reception device, setting a relay time in the test measurement signal when relaying the test measurement signal toward the reception device, and an analysis device including a reception unit receiving two or more relay time measurement results of the relay devices, each of which is obtained by the reception device when transmission/reception of the test measurement signal is performed two or more times by the transmission device and the reception device, a calculation unit calculating a quality index value of a communication section between the relay devices based on the relay time measurement results, and an output unit outputting the communication quality index value of the communication section.

### CROSS-REFERENCE TO RELATED APPLICATION

This is a continuation of Application PCT/JP2003/009934, filed on Aug. 5, 2003, now pending, the contents of which are herein wholly incorporated by reference.

### BACKGROUND OF THE INVENTION

1. Field of the Invention

The present invention relates to a technique for detecting a section (interval) assumed to cause communication quality degradation in a communication path. The present invention relates, for example, to a technique for detecting a section causing voice (speech) quality degradation on a voice path of VOIP (Voice over IP).

2. Description of the Related Art

In recent years, there is known a technology for transferring voice information using an IP (Internet Protocol) network based on a VoIP technology to realize a call (communication) between terminals (referred to as “Internet Telephony” technology). According to this technology, as shown in FIGS. 33 and 34 for example, a VOIP gateway (VOIP GW) for performing protocol conversion is installed at a border between the IP network and the existing circuit switch network. When both or one of terminals for the call is a terminal compatible with the circuit switch network (for example, a PSTN-compatible telephone), protocol conversion between the circuit switch network and the IP network is performed at the VOIP gateway (for example, conversion between an analog voice signal and an IP voice packet). On the other hand, when the terminal for the call functions as an IP terminal (IP telephone), the above-mentioned protocol conversion is not performed for this terminal. Similar to the normal IP data packet, the IP voice packet is transferred to its destination across the IP network via routers prepared in the IP network.

During the call using such VOIP technology, avoiding voice quality degradation in the IP network is required. Therefore, conventionally, the following system for specifying a section causing voice quality degradation in the IP network has been proposed.

For example, as shown in FIG. 33, a dedicated monitor device is prepared for each subnet constituting the IP network, and the monitor device monitors an RTP (Real-time Transport Protocol) packet passing through the subnet. An analysis device connected to the IP network is notified of the result of the monitoring device in terms of a signal log. Then, the analysis device analyzes the signal log from each monitoring device to specify the section causing voice quality degradation in the IP network.

Alternatively, as shown in FIG. 34, there is disclosed a method for voice quality management for each call, with which a threshold of voice quality management information for each call is previously set remotely by an operation support system in plural gateways (end points of VOIP such as VOIP gateways) for collecting voice quality management information for respective calls, the operation support system is configured to store information on a connection relation of IP addresses previously allocated to communication devices, the operation support system is notified of corresponding call quality information when the degradation exceeds the threshold set in the gateway, and the operation support system checks the quality information notified from the plural gateways against the IP address connection relation information stored in the operation support system piece by piece, to thereby display a path with quality degradation (for example, Patent Document 1). In FIG. 34, the VOIP gateway and the IP telephone functioning as the end points of VOIP notify the analysis device functioning as the operation support system, of corresponding call quality information in terms of an alarm when the degradation exceeds the threshold of the voice quality management information.

In addition, for example, the following Patent Documents 2 to 6 and as prior art documents disclose techniques relating to the present invention.

[Patent Document 1] JP 2002-271392 A

[Patent Document 2] JP 2002-232475 A

[Patent Document 3] JP 2001-177573 A

[Patent Document 4] JP 2000-307637 A

[Patent Document 5] JP 2002-64545 A

[Patent Document 6] JP 2002-141938 A

However, the conventional techniques shown in FIGS. 33 and 34 have the following problems.

First, in the system shown in FIG. 33, monitoring devices need to be installed in all sections through which voice packets pass in the IP network. This leads to a problem of substantial costs.

Second, the monitoring device shown in FIG. 33 has a structure of being connected to the VoIP gateway or router via a LAN (Local Area Network). Therefore, when the devices are connected to each other via a network different from the LAN (for example, a WAN such as an ATM network or an ISDN network) (in the example shown in FIG. 33, a section between a router #C and a router #D or a section between a router #B and an IP telephone #B), monitoring devices corresponding to a network structure connecting therebetween need to be installed. Also, by installing the monitoring devices, the network structure may change in some sections.

Third, in the system shown in FIG. 33, during measurement of call quality, it is necessary to predict a path between calling devices (telephones) and set addresses of the calling devices in the relating monitoring devices.

Fourth, in the system shown in FIG. 33, the analysis device collects signal logs from plural monitoring devices, and load on the IP network is substantial.

Fifth, in the system shown in FIG. 34, if the number of alarms received by the analysis device is small, it is difficult to specify a “defective section” causing voice quality degradation.

Sixth, in the system shown in FIG. 34, even when the number of alarms is large, if the call path has a deviation, it is difficult to specify a “defective section” causing voice quality degradation.

Seventh, in the system shown in FIG. 34, in the case of calling via a VOIP network that does not issue alarm notifications, for example, via another VOIP carrier network, it is impossible to determine whether a “defective section” exists in its own network or a “defective section” exists in the other VOIP carrier network.

Eighth, in the system shown in FIG. 34, if the number of alarm notifications increases, the load on the network accordingly increases, leading to a problem of alarm induction. To solve this problem, an additional network for allowing alarms to pass therethrough needs to be structured.

### SUMMARY OF THE INVENTION

An object of the present invention is to provide a technique for reducing the number of devices used for specifying a communication section assumed to cause quality degradation as compared with the prior art.

Another object of the present invention is to provide a technique for reducing load on a network as compared with techniques of the prior art.

The present invention is a system for analyzing quality of communication sections, comprising:

a transmission device transmitting a test measurement signal;

a reception device receiving the test measurement signal;

relay devices each located on a transmission path of the test measurement signal between the transmission device and the reception device, setting a relay time in the test measurement signal when relaying the test measurement signal toward the reception device; and

an analysis device including:
a reception unit receiving two or more relay time measurement results of the relay devices, each of which is obtained by the reception device when transmission/reception of the test measurement signal is performed two or more times by the transmission device and the reception device;
a calculation unit calculating a quality index value of a communication section between the relay devices based on the relay time measurement results; and
an output unit outputting the communication quality index value of the communication section.

### BRIEF DESCRIPTION OF THE DRAWINGS

FIG. 1 shows a structure example of an analysis system for quality in a communication section according to an embodiment;

FIG. 2 shows an outline of a measuring method (test) in the analysis system;

FIG. 3 shows an example of a measurement (test) sequence in the analysis system;

FIG. 4 is a block diagram showing a structure example of an analysis device;

FIG. 5 is a block diagram showing a structure example of a transmission device;

FIG. 6 is a block diagram showing a structure example of a reception device;

FIG. 7 is a block diagram showing a structure example of a relay device;

FIG. 8 shows a field structure example of a test measurement signal;

FIG. 9 shows a field structure example of a test start instruction signal;

FIG. 10 shows a field structure example of a test call setting signal;

FIG. 11 shows a field structure example of a test call setting response signal;

FIG. 12 shows a field structure example of a test log signal;

FIG. 13 shows a field structure example of a passing test device number notification signal;

FIG. 14 is a flowchart showing a transmission process example of a test measurement signal executed by the transmission device;

FIG. 15 is a flowchart showing a relay process example of the test measurement signal executed by the relay device;

FIG. 16 is a flowchart showing a reception process example of the test measurement signal executed by the reception device;

FIG. 17 shows a data structure example of a measurement log table created by the analysis device;

FIG. 18 shows a data structure example of a fluctuation calculation table created by the analysis device;

FIG. 19 is an explanatory diagram of the fluctuation calculation principle;

FIG. 20 is a flowchart showing an example of a section “fluctuation” calculation process executed by the analysis device;

FIG. 21 shows a data structure example of a fluctuation calculation result table created by the analysis device;

FIG. 22 is a flowchart showing a reception process example of a passing test device number notification signal executed by the transmission device;

FIG. 23 is a flowchart showing a transmission process example of a test start instruction signal executed by the analysis device;

FIG. 24 is a flowchart showing a reception process example of the test start instruction signal executed by the transmission device;

FIG. 25 is a flowchart showing a reception process example of a test call setting signal executed by the reception device;

FIG. 26 is a flowchart showing a reception process example of a test log signal executed by the analysis device;

FIG. 27 shows a field structure example of the test measurement signal when passing devices are identified;

FIG. 28 shows a field structure example of the test log signal when the passing devices are identified;

FIG. 29 is a flowchart showing a transmission process example of the test measurement signal executed by the transmission device when the passing devices are identified;

FIG. 30 is a flowchart showing a relay process example of the test measurement signal executed by the relay device when the passing devices are identified;

FIG. 31 is a flowchart showing a reception process example of the test measurement signal executed by the reception device when the passing devices are identified;

FIG. 32 shows a data structure example of the measurement log table when the passing devices are identified;

FIG. 33 is an explanatory diagram of the prior art; and

FIG. 34 is an explanatory diagram of the prior art.

### DETAILED DESCRIPTION OF THE PREFERRED EMBODIMENTS

Hereinafter, preferred embodiments for carrying out the present invention will be described with reference to the drawings. The structures of embodiments merely represent examples, and the present invention is not limited to the structures of the embodiments.

<Overall Structure>

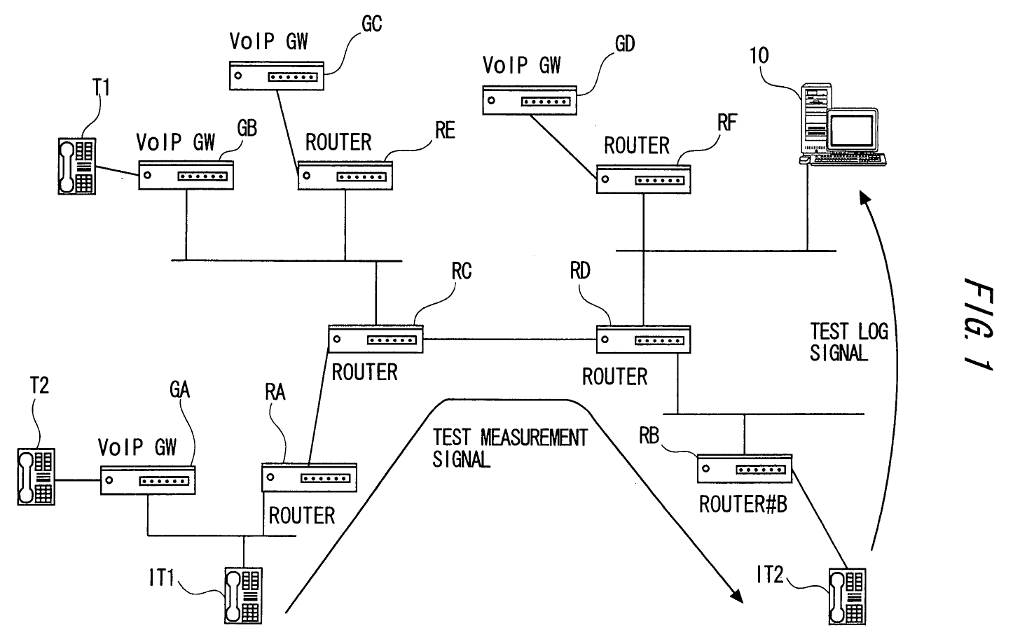

FIG. 1 shows an overall structure example of a quality degradation section detection system in communication paths according to the present invention. The system shown in FIG. 1 includes plural routers constituting an IP network, VOIP gateways installed at borders between the IP network and circuit switch networks (e.g., PSTN), telephones functioning as communication terminals connected to the VoIP gateway via the circuit switch network, an IP telephone connected to a LAN or router constituting the IP network, and an analysis device connected to the IP network.

The IP network shown in FIG. 1 includes routers RA, RB, RC, RD, RE and RF connected to VoIP gateways GA to GD. Then, telephone Tl and T2 are connected to the VOIP gateways GB and GA, respectively. An IP telephone IT1 is connected to the router RA via the LAN, and an IP telephone IT2 is connected to the router RB. Then, an analysis device 10 is contained in the LAN, which contains the router RD and RF.

The VOIP gateways GA to GD and the IP telephones IT1 and IT2 are respectively configured to have functions of a “transmission device” and a “reception device” according to the present invention. The routers RA to RF are each configured to have a function of a “relay device” according to the present invention. Note that the router can also have functions of the “transmission device” and the “reception device”. Then, the analysis device 10 is configured to have a function of an “analysis device” of the present invention.

<Outline of Measurement Method>

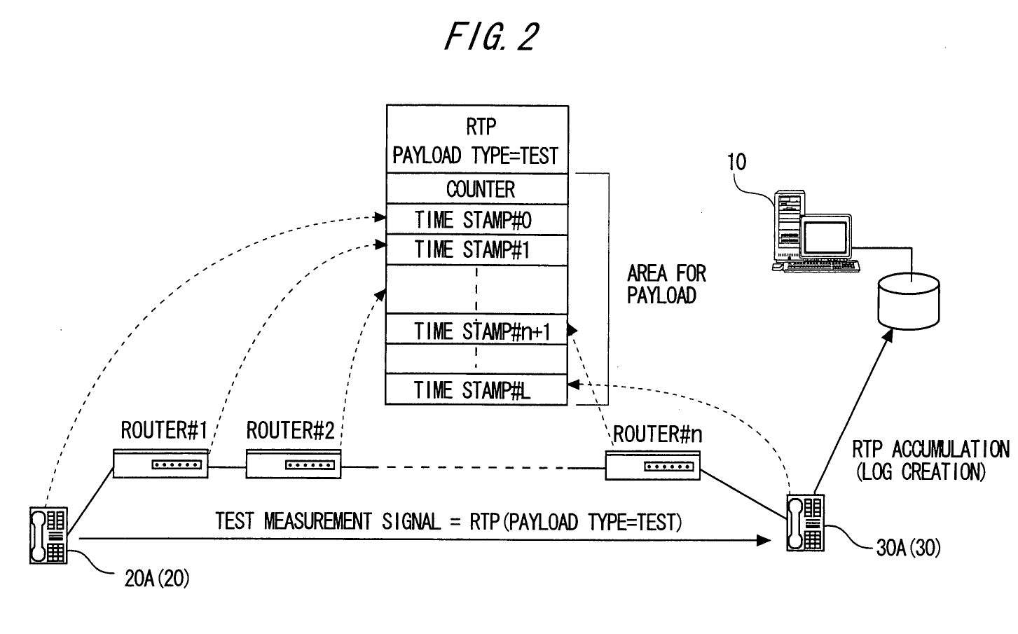

FIG. 2 is an explanatory diagram of a measurement (test) method for specifying a quality degradation section according to the present invention. FIG. 2 shows an outline where log creation on a “test measurement signal” transmitted from a transmission device 20 to a reception device 30 via a “router #1”, a “router #2”, . . . , a “router #n (n is a natural number)” is performed by the analysis device 10.

In FIG. 2, an IP telephone 20A on a voice transmission side functions as the transmission device 20, an IP telephone 30A on a voice reception side functions as the reception device 30, and routers #1 to #n respectively function as the “relay device” for relaying packets transmitted/received between the IP telephones 20A and 30A.

To specify a voice degradation section in call (voice communication) by the analysis device 10, a test measurement signal is transmitted/received between the transmission device 20 and the reception device 30 for voice information, the reception device 30 notifies the analysis device 10 of the test measurement signal, and the analysis device 10 accumulates the test measurement signal in database (log creation).

For example, an RTP packet (payload type=test) is applicable as the test measurement signal. In an area for payload (payload area) of the RTP packet, a counter storage area and plural timestamp storage areas are prepared.

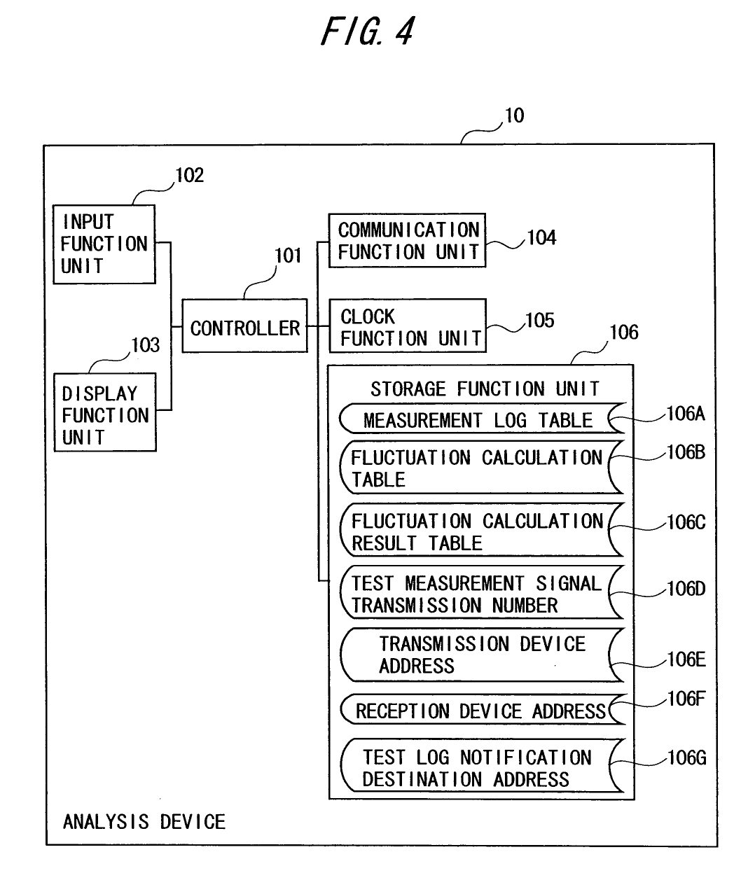

When transmitting the test measurement signal (RTP packet) the transmission device 20 stores a timestamp (“TimeStamp #0” in FIG. 2) indicating a transmission time in the payload of the RTP packet and transfers the packet to the next reception node (router #1 here). When relaying the RTP packet, the respective relay devices (routers #1 to #n) store a timestamp indicating a passing time (relay time) in a corresponding area of its payload and transfers the packet to the next reception node. Upon reception of the RTP packet, the reception device 30 stores a timestamp indicating a reception time in a corresponding area of its payload and notifies the analysis device 10 of the packet. Upon reception of the RTP packet, the analysis device 10 accumulates payload contents in database (storage function unit 106: FIG. 4) (log creation). The analysis device 10 analyses the payload contents and creates information for specifying the voice degradation section.

In the example shown in FIG. 2, between the transmission device 20 and the reception device 30, for example, a communication path is set for transmitting voice information in VOIP from the transmission device 20 to the reception device 30. At this time, a section between the transmission device and the router #I, a section between routers, and a section between the router #n and the reception device each constitute a voice information communication section. The analysis device 10 of this embodiment sets a communication path (test call) for transmitting/receiving a test measurement signal between the transmission device 20 and the reception device 30, obtains the fluctuation amount or average fluctuation amount between the communication sections as an index value of quality between the communication sections based on results of measuring timestamps (transmission time, relay time, and reception time) at least twice obtained from a test (performing transmission/reception of test measurement signals at least twice), and outputs the index value to specify a section assumed to have degradation in communication quality (voice quality, etc.). The output index value can be presented (displayed on a display, etc.) along with addresses of the transmission device and the reception device and identification information on devices corresponding to the start point or the end point of communication sections.

<Measurement Sequence Example>

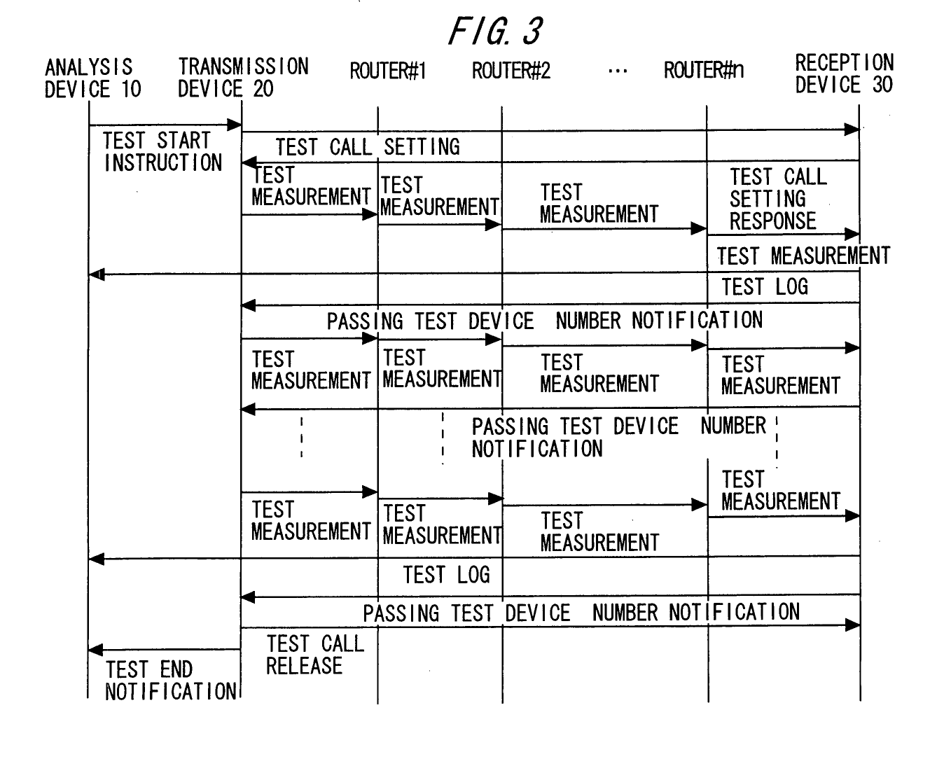

FIG. 3 shows a measurement sequence example. FIG. 3 shows operation examples of the transmission device 20, the routers #1 to #n, the reception device 30, and the analysis device 10 shown in FIG. 2.

In FIG. 3, first, the analysis device 10 issues to the transmission device 20 a start instruction of a packet passing test for a voice communication path between the transmission device 20 and the reception device 30. The start instruction includes the number of test measurement signal transmission (number of test times).

Then, the transmission device 20 transmits a setting signal for a test call (test call setting signal) to the reception device 30. Upon reception of the test call setting signal, the reception device 30 transmits a test call setting response signal corresponding to the test call setting signal to the transmission device 20. Thus, the test call is set between the transmission device 20 and the reception device 30.

Thereafter, the transmission device 20 transmits the test measurement signal to the reception device 30. The test measurement signal arrives at the reception device 30 via the routers #1 to #n. At this time, the transmission device 20, the routers #1 to #n, and the reception device 30 store timestamps in a predetermined area of the test measurement signal (RTP packet). Then, the reception device 30 notifies the analysis device 10 of the payload contents of the RTP packet as a test log.

At this time, the reception device 30 may notify the analysis device 10 of the RTP packet itself, and extract the RTP packet payload to notify the analysis device 10 of the extracted packet payload. Alternatively, the reception device 30 may be configured to process the payload contents of the RTP packet into a recording format to be stored in the analysis device 10 for notification.

Thereafter, based on the number of timestamps stored in the RTP packet payload, the reception device 30 finds out the number of devices (passing test device number) through which the RTP packet passes, and notifies the transmission device 20 of the passing test device number.

Such operation from the transmission of the test measurement signal by the transmission device 20 to the transmission of the passing test device number by the reception device 30 (refereed to as “test operation”) is repeatedly performed by the number of test times included in the start instruction from the analysis device 10.

After the test operation is performed by the number of test times, the transmission device 20 transmits a test call release signal to the reception device 30. Thus, the test call is released. When the test call is released, the transmission device 20 notifies the analysis device 10 of end of the test.

<Analysis Device>

FIG. 4 is a block diagram of a structure example of the analysis device 10. The analysis device 10 can be structured of a computer like a general computer such as a personal computer (PC) or a work station (WS), a dedicated computer, or a dedicated server machine.

As shown in FIG. 4, the analysis device 10 includes: a controller 101; and an input function unit 102, a display function unit 103, a communication function unit 104, a clock function unit 105, and the storage function unit 106, which are connected to the controller 101.

The input function unit 102 is a function portion for designating test conditions, etc. of the transmission device 20 and the reception device 30 by a person. The input function unit 102 is realized using, for example, a keyboard (including buttons and keys) or a pointing device (mouse, etc.).

The display function unit 103 is a function portion for checking test conditions or test results by a person. The display function unit 103 is realized using a display device.

The communication function unit 104 is a function portion for communicating with the transmission device 20, the reception device 30, and other devices connected via the network. The communication function unit 104 is realized using a network interface circuit according to a connection (access) format to the IP network such as a LAN interface.

The storage function unit 106 is a function portion for storing a program and various data necessary for analysis. The storage function unit 106 is composed using a readable/writable storage medium such as a RAM or a hard disk.

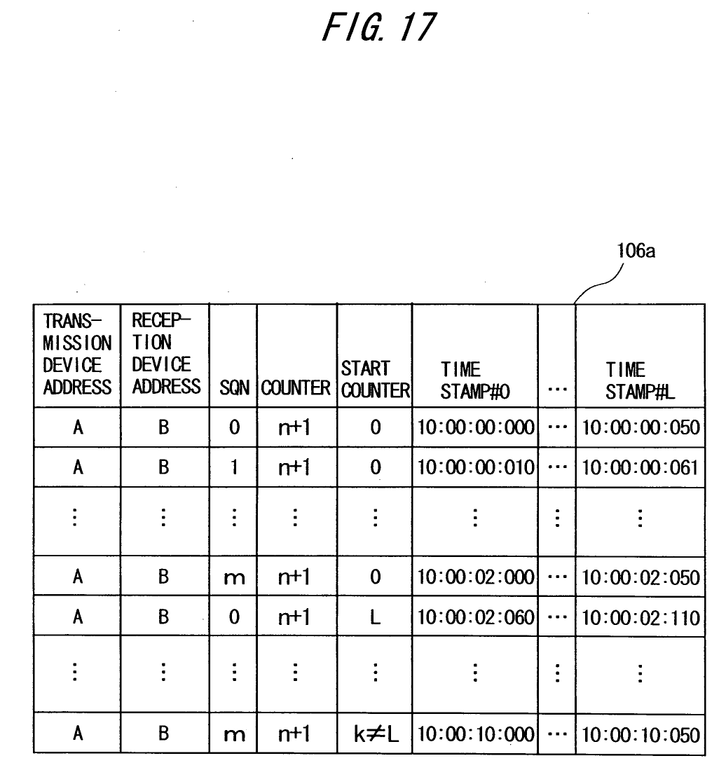

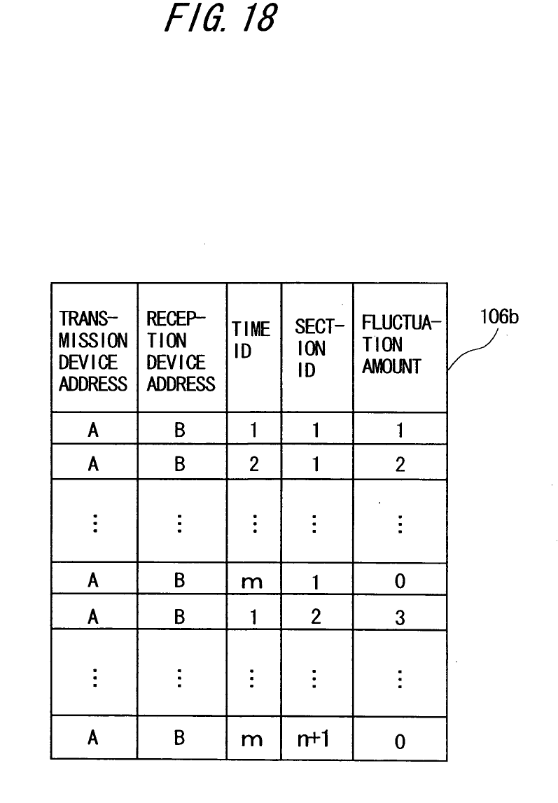

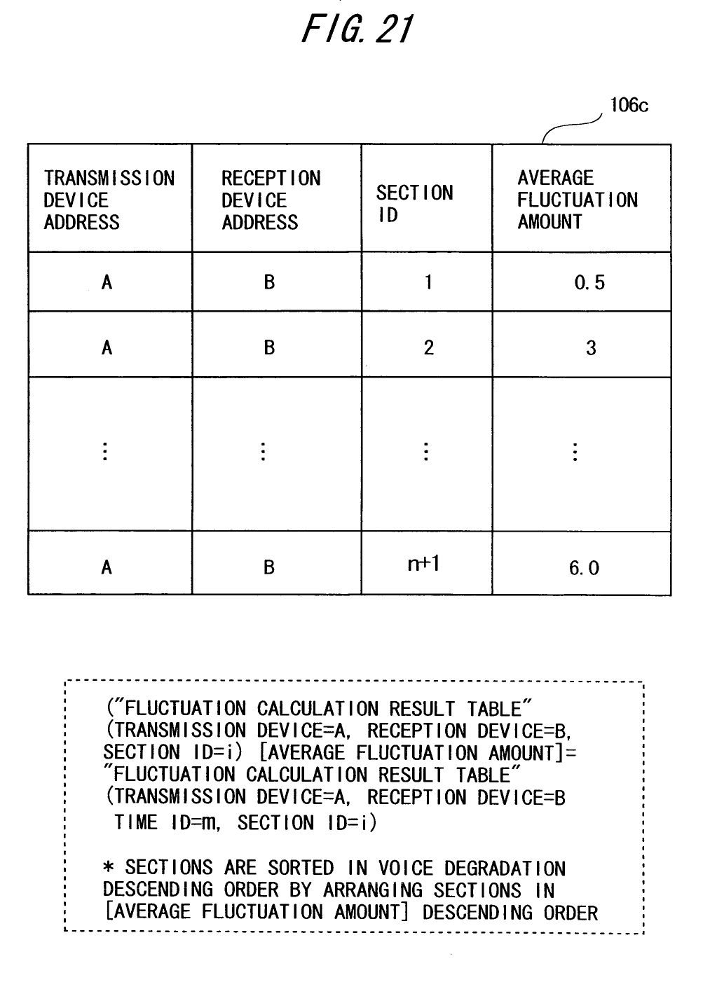

The storage function unit 106 includes: the program storage area; and storage areas 106A to 106G for storing a measurement log table 106a (FIG. 17), a fluctuation calculation table 106b (FIG. 18), a fluctuation calculation result table 106c (FIG. 21), a test measurement signal transmission number, a transmission device address, a reception device address, a test log notification destination address, respectively.

The clock function unit 105 is a function portion for performing time count. The clock function unit 105 counts time.

The controller 101 is composed of a processor such as a CPU, a main memory (RAM, etc.), a ROM, an input/output unit and device driver for peripheral devices, and the like. The controller 101 executes the program stored in the storage function unit 106 to control the input function unit 102, the display function unit 103, the communication function unit 104, the clock function unit 105, and the storage function unit 106, thereby realizing the function of the analysis device 10. Note that, the controller 101 can also be realized by a dedicated hardware logic circuit.

The controller 101 corresponds to reception unit, calculation unit (measurement log table creation unit, fluctuation calculation unit, fluctuation calculation result table creation unit), and output unit in the present invention.

<Transmission Device>

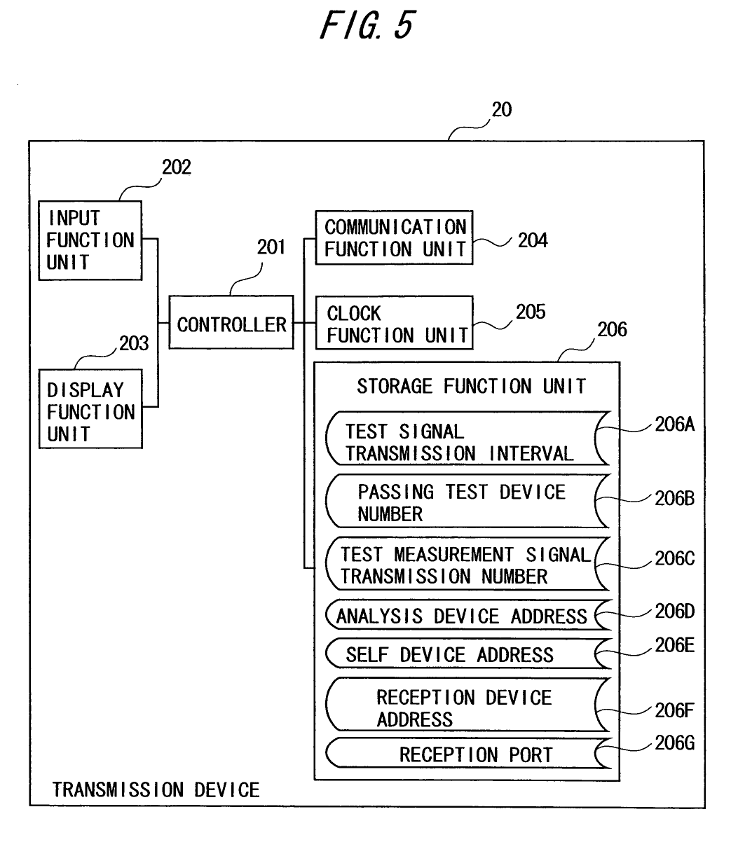

FIG. 5 is a block diagram of a structure example of the transmission device 20. The transmission device 20 can be composed using a dedicated device or computer functioning as an IP telephone or VoIP gateway, or a general computer such as a PC, WS, or PDA (Personal Digital Assistants).

As shown in FIG. 5, the transmission device 20 includes: a controller 201; and an input function unit 202, a display function unit 203, a communication function unit 204, a clock function unit 205, and a storage function unit 206, which are connected to the controller 201.

The input function unit 202 is a function portion for designating test conditions, etc. of the transmission device 20 and the reception device 30 by a person. The input function unit 202 is realized using, for example, a keyboard including buttons and keys or a pointing device (mouse, etc.).

The display function unit 203 is a function portion for checking operation conditions and various data of the transmission device 20 by a person. The display function unit 203 is composed using a display device.

The communication function unit 204 is a function portion for communicating with the analysis device 10, the reception device 30, the relay device, and other devices connected via the network. The communication function unit 204 is realized using a network interface circuit according to a connection (access) format to the IP network such as a LAN interface.

The storage function unit 206 is a function portion for storing a program and various data necessary for analysis. The storage function unit 206 is composed using a readable/writable storage medium such as a RAM or a hard disk.

The storage function unit 206 includes: the program storage area; and storage areas 206A to 206G for storing a test signal transmission interval, the passing test device number, the test measurement signal transmission number, an analysis device address, its own device address, the reception device address, and identification information of a reception port (reception port number), respectively.

The clock function unit 205 is a function portion for performing time count, which counts current time.

The controller 201 is composed of a processor such as a CPU, a main memory (RAM, etc.), a ROM, an input/output unit and device driver for peripheral devices, and the like. The controller 201 executes the program stored in the storage function unit 206 to control the input function unit 202, the display function unit 203, the communication function unit 204, the clock function unit 205, and the storage function unit 206, thereby realizing the function of the transmission device 20. Note that, the controller 201 can also be realized by a dedicated hardware logic circuit.

<Reception Device>

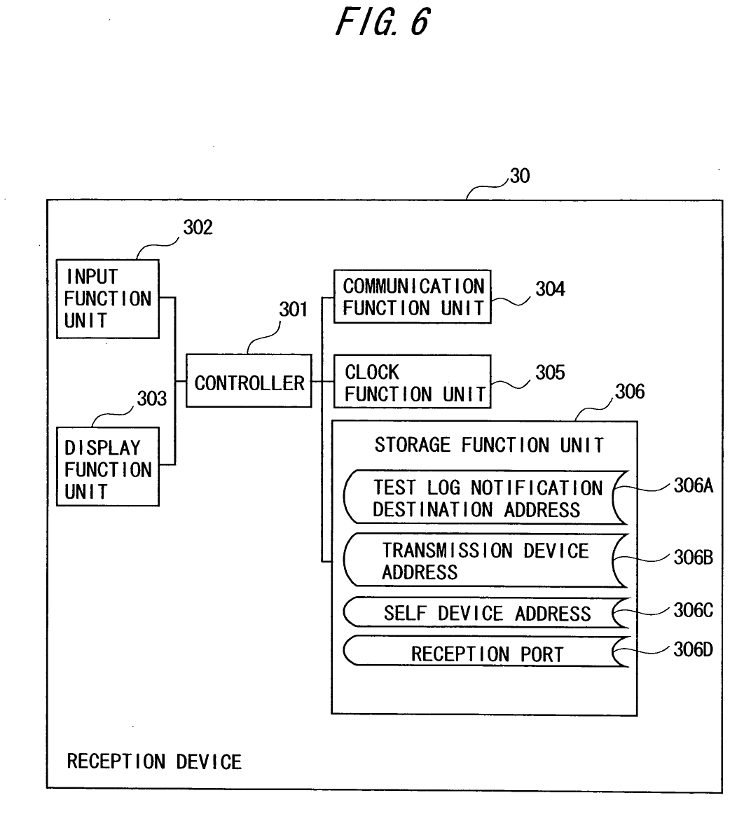

FIG. 6 is a block diagram of a structure example of the reception device 30. The reception device 30 can be composed using a dedicated device or computer functioning as an IP telephone or VOIP gateway, or a general computer such as a PC, WS, or PDA (Personal Digital Assistants).

As shown in FIG. 6, the reception device 30 includes: a controller 301; and an input function unit 302, a display function unit 303, a communication function unit 304, a clock function unit 305, and a storage function unit 306, which are connected to the controller 301.

The input function unit 302 is a function portion for designating operation conditions of the reception device 30 by a person. The input function unit 302 is realized using, for example, a keyboard including buttons and keys or a pointing device (mouse, etc.).

The display function unit 303 is a function portion for checking operation conditions and various data of the reception device 30 by a person. The display function unit 303 is composed using a display device.

The communication function unit 304 is a function portion for communicating with the analysis device 10, the transmission device 20, the relay device, and other devices connected via the network. The communication function unit 304 is realized using a network interface circuit according to a connection (access) format to the IP network such as a LAN interface.

The clock function unit 305 is a function portion for performing time count, which counts current time.

The storage function unit 306 is a function portion for storing a program and various data necessary for analysis. The storage function unit 306 is composed using a readable/writable storage medium such as a RAM or a hard disk.

The storage function unit 306 includes: the program storage area; and storage areas 306A to 306G for storing the test log notification destination address, the transmission device address, its own device address, identification information of a reception port (reception port number), respectively.

The controller 301 is composed of a processor such as a CPU, a main memory (RAM, etc.), a ROM, an input/output unit and device driver for peripheral devices, and the like. The controller 301 executes the program stored in the storage function unit 306 to control the input function unit 302, the display function unit 303, the communication function unit 304, and the storage function unit 306, thereby realizing the function of the reception device 30. Note that, the controller 301 can also be realized by a dedicated hardware logic circuit.

Note that, a device functioning as the transmission device 20 or the reception device 30 (for example, an IP telephone terminal or a VOIP gateway) can be structured to have both the functions of the transmission device 20 and the reception device 30.

<Relay Device>

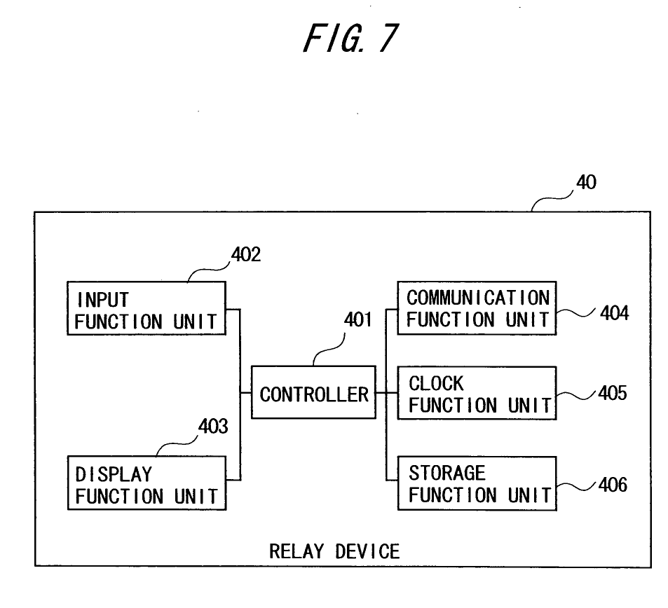

FIG. 7 is a block diagram of a structure example of the relay device 40. The relay device 40 is composed using, for example, a router device. As shown in FIG. 7, the relay device 40 includes a controller 401, an input function unit 402, a display function unit 403, a communication function unit 404, a clock function unit 405, and a storage function unit 406.

The input function unit 402 is a function portion for designating operation conditions of the relay device 40 by a person. The input function unit 402 is realizedusing, for example, a keyboard including buttons and keys or a pointing device (mouse, etc.).

The display function unit 403 is a function portion for checking operation conditions and various data of the relay device 40 by a person. The display function unit 403 is composed using a display device.

The communication function unit 404 is a function portion for communicating with the analysis device 10, the transmission device 20, the reception device 30, and other devices connected via the network. The communication function unit 404 is realized using a network interface circuit according to a connection (access) format to the IP network such as a LAN interface.

The clock function unit 405 is a function portion for performing time count.

The storage function unit 406 is a function portion for storing a program and various data necessary for analysis. The storage function unit 406 is composed using a readable/writable storage medium such as a RAM or a hard disk.

The controller 401 is composed of a processor such as a CPU, a main memory (RAM, etc.), a ROM, an input/output unit and device driver for peripheral devices, and the like. The controller 401 executes the program stored in the storage function unit 406 to control the input function unit 402, the display function unit 403, the communication function unit 404, the clock function unit 405, and the storage function unit 406, thereby realizing the function of the relay device 40. Note that, the controller 401 can also be realized by a dedicated hardware logic circuit.

<Test Measurement Signal Structure>

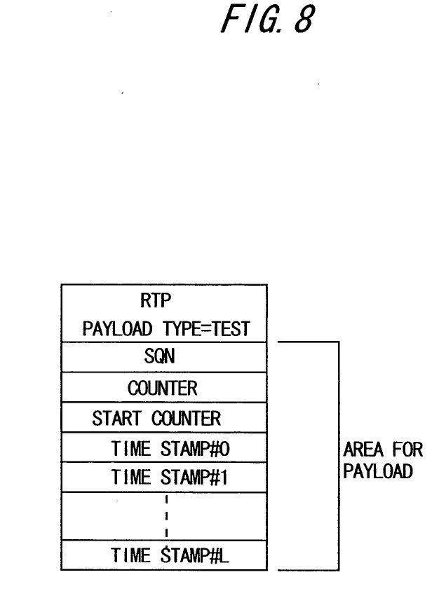

FIG. 8 shows a field structure example of a test measurement signal. As described above, an RTP packet whose payload type is “test” is applicable as the test measurement signal.

In an area for payload of the RTP packet, fields for storing a sequence number (SQN), a counter (Counter), a start counter (StartCounter), plural timestamps (TimeStamp #0 to #L (L is a natural number)) are prepared. Here, “L” is a constant value obtained by subtracting 1 from the number of timestamps that can be set in the test measurement signal (settable number −1).

Here, the sequence number is identification information for identifying individual test measurement signals, and used for detecting duplicate reception of the test measurement signal.

The counter value counts up each time the test measurement signal is relayed by the relay device 40. The counter value is used for specifying a timestamp setting position by the respective relay devices 40.

A value indicating where timestamp setting starts between the transmission device 20 and the reception device 30 is set as the start counter. The start counter value is used along with the counter value, and employed for specifying a timestamp setting position by the respective relay devices 40.

The timestamp is information indicating a transmission time of the test measurement signal at the transmission device 20, passing times at the respective relay devices 40, and a reception time at the reception device 30. The timestamp is set at the transmission device 20, the relay devices 40, and the reception device 30, according to contents in the measurement target sections.

<Test Start Instruction Signal Structure>

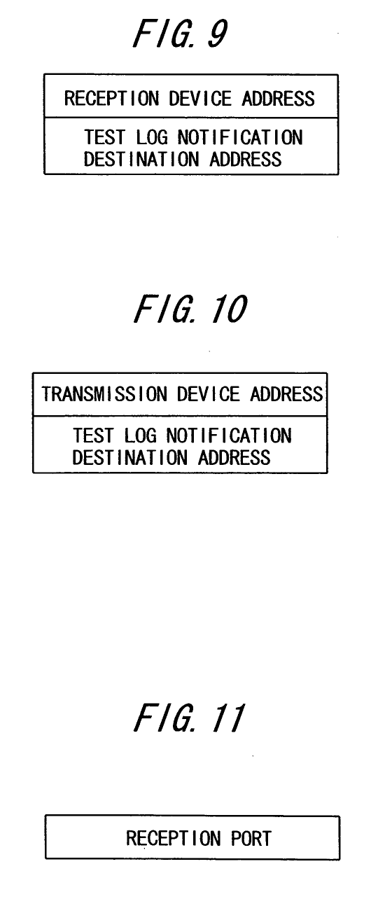

FIG. 9 shows a field structure example of a test start instruction signal. The test start instruction signal has fields for storing the reception device address and the test log notification destination address.

The reception device address is an address of the reception device 30 corresponding to the destination of the test measurement signal. The reception device address is used for designating the reception device 30 that is the destination to which the test measurement signal is transmitted from the transmission device 20.

The test log notification destination address is an address of the analysis device 10. The test log notification destination address is used for designating the analysis device 10 corresponding to the destination of the test log signal.

<Test Call Setting Signal Structure>

FIG. 10 shows a field structure example of a test call setting signal. The test call setting signal has fields for storing the transmission device address and the test log notification destination address, respectively.

The transmission device address is an address of the transmission device 20 and used for identifying the transmission device 20 that is the source of the test measurement signal. The test log notification destination address is an address of the analysis device 10 and used for designating the analysis device 10 corresponding to the destination of the test log signal.

<Test Call Setting Response Signal Structure>

FIG. 11 shows a field structure example of a test call setting response signal. The test call setting response signal includes a field for storing identification information of the reception port (reception port number).

The reception port number is used for identifying the reception port at which the reception device 30, which corresponds to the destination of the test measurement signal, is ready to receive the test measurement signal.

<Test Log Signal Structure>

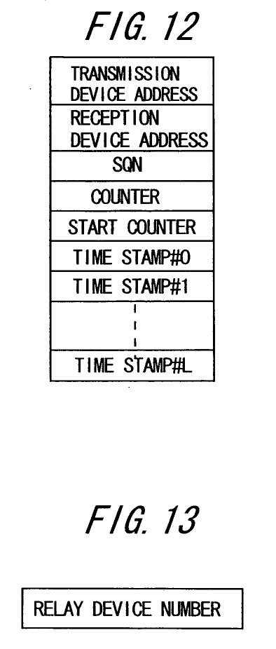

FIG. 12 shows a field structure example of a test log signal. The test log signal includes fields for storing the transmission device address, the reception device address, the sequence number (SQN), the counter (Counter), the start counter (StartCounter), and the timestamps (TimeStamp) according to the number of the relay devices 40.

The transmission device address is an address of the transmission device 20, and used for identifying the transmission device 20 that is the source of the test measurement signal. The reception device address is an address of the reception device 30, and used for identifying the reception device 30 that is the destination of the test measurement signal.

“SQN”, “Counter”, “StartCounter”, and “TimeStamp” are used for setting (storing) “SQN”, “Counter”, “StartCounter”, and “TimeStamp” corresponding to the test measurement signal (included in the test measurement signal) in the test log signal.

<Structure of Passing Test Device Number Notification Signal>

FIG. 13 shows a field structure example of a passing test device number notification signal. The passing test device number notification signal includes a field for storing the relay device number. The relay device number is used for identifying the number of the relay devices 40 through which the test measurement signal has gone (passed).

<Test Measurement Signal Transmission Process>

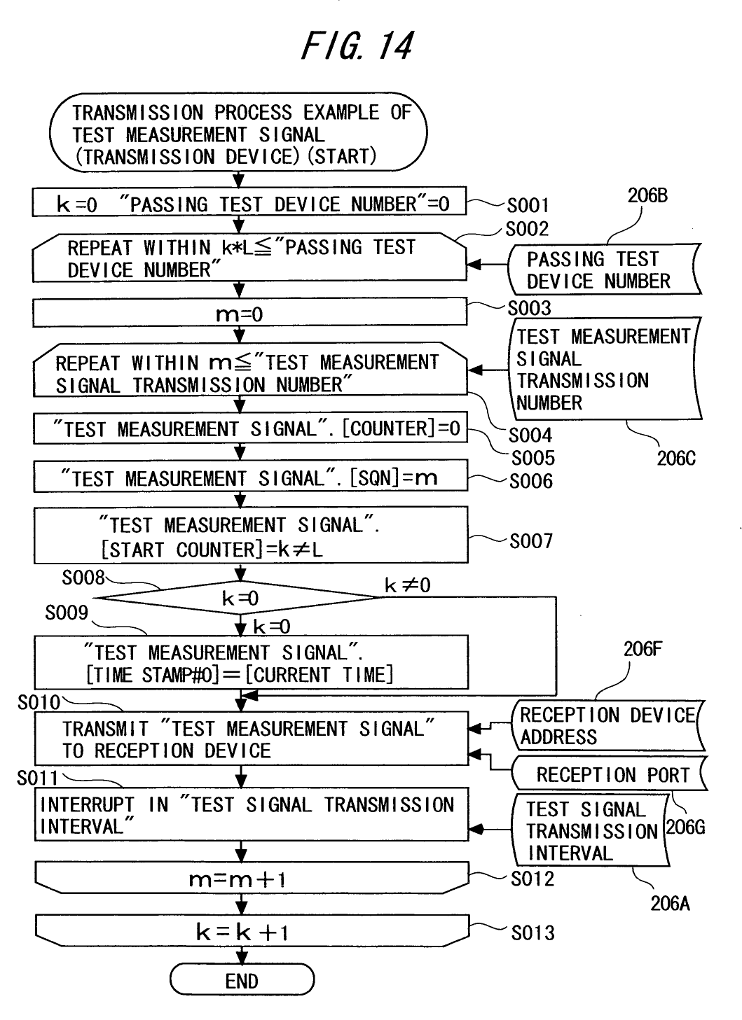

FIG. 14 is a flowchart of a test measurement signal transmission process example at the transmission device 20. The transmission process is performed when the controller 201 (FIG. 5) of the transmission device 20 executes the program stored in the storage function unit 206. The transmission process starts after a test call is set based on the test start instruction signal from the analysis device 10 (see FIG. 3).

In FIG. 14, first, the controller 201 sets a variable “k” as 0 and sets the passing test device number as 0 (S001).

Next, the controller 201 refers to the passing test device number stored in a storage area 206B of the storage function unit 206 to judge whether “k*L=passing test device number” is met (S002). At this time, while the condition is met, the following process in S003 to S013 is repeatedly performed. Note that, in a state immediately after setting the test call (state after ending S001) a value of the passing test device number 206B is 0.

Next, the controller 201 sets a variable “m” as 0 (S003).

Next, the controller 201 refers to the test measurement signal transmission number stored in a storage area 206C of the storage function unit 206 to judge whether “m=test measurement signal transmission number” is met (S104). At this time, while the condition is met, the following process in S005 to S012 is repeatedly performed. Note that, in a state immediately after ending S003, the test measurement signal transmission number notified by the analysis device 10 is set in the storage area 206C.

Next, the controller 201 sets 0 in the counter field in the payload area of the test measurement signal (RTP packet) (S005).

Next, the controller 201 sets the current variable “m” value in the sequence number field in the payload area of the test measurement signal (S006).

Next, the controller 201 sets the current “k*L” value in the start counter field in the payload area of the test measurement signal (S007).

Next, the controller 201 judges whether the current variable the current variable “k” value is 0 (S008) At this time, when the variable “k” value is not 0 (S008; k≠0), the process proceeds to S010, and when it is 0, the process proceeds to S009 (S008; k≠0) the process proceeds to S009.

In S009, the controller 201 sets the current time obtained from the clock function unit 205 in the storage position of the first timestamp in the payload area of the test measurement signal (TimeStamp#0).

In S010, the controller 201 reads out the reception device address stored in a storage area 206F of the storage function unit 206 and the reception port number stored in a storage area 206G to set the reception device address and the reception port number in the test measurement signal, and transmits it toward the reception device 30 from the communication function unit 204.

Then, during a period indicated by the test signal transmission section stored in the storage area 206A of the storage function unit 206, the controller 201 stops the process (S011).

Thereafter, when the test signal transmission section elapses, the controller 201 adds 1 to the variable “m” (S012), and returns the process to S004. At this time, the controller 201 advances the process to S013 when “m=the test measurement signal transmission number” is not met. With the above process, the transmission device 20 transmits the test measurement signal by the predetermined times indicated by the storage area of the test measurement signal transmission number 206C.

In S013, the controller 201 adds 1 to the variable “k” value and returns the process to S002. In S002, the controller 201 again judges whether the condition “k*L=passing test device number” is met. Note that, the value of the passing test device number referred to again in the judging process in S002 (value set in the storage area 206B) is the passing test device number notified by the reception device 30 to the transmission device 20. Then, when the condition is not met, the control device 201 ends the test measurement signal transmission process.

Note that, the value “k*L” set as the start counter value is set while assuming a case where the passing test device number of the test measurement signal (number n of the relay devices 40 through which the test measurement signal passes: n+1 when the reception device 30 is included) is equal to or larger than “L”.

That is, when the passing test device number is equal to or larger than the constant “L”, the number of the transmission devices 20 is set as “0”, and the process of S003 to S012 (k=0) is performed for the relay devices 40 existing between there and the position “L”. Thereafter, the process of S003 to S012 (k=1) is performed for the relay devices from the relay device 40 at the position “L” to the relay device 40 at the position “2L” (sometimes the reception device 30 may also be included). In this way, the process of S003 to S012 is repeatedly performed until the condition of S002 (k*L=passing test device number) is not met. Accordingly, timestamps can be obtained at all the devices existing between the transmission device 20 and the reception device 30 (on the voice path) (the transmission device 20, the reception device 30, and the relay devices 40).

<Test Measurement Signal Relay Process>

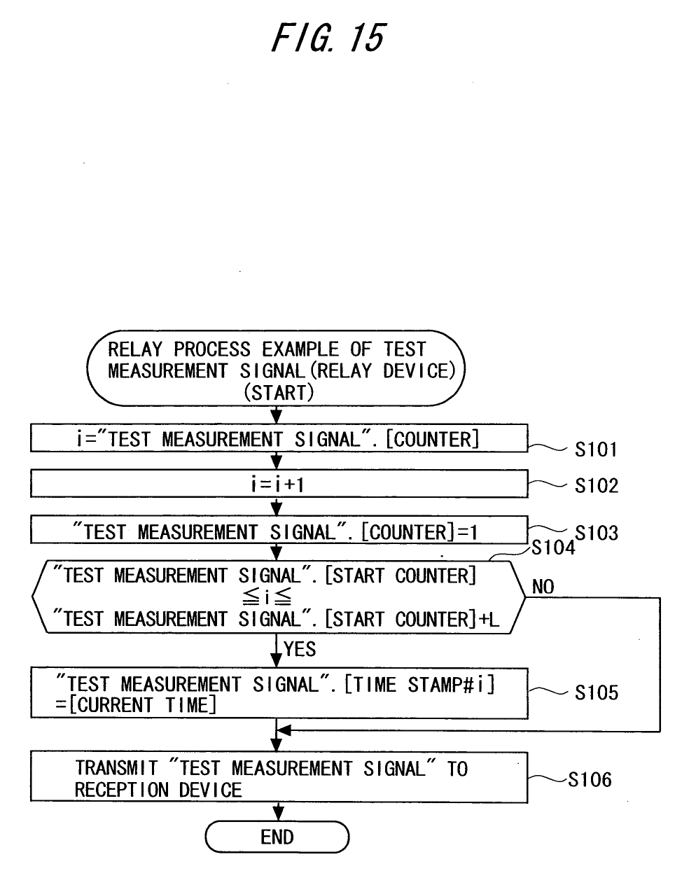

FIG. 15 is a flow chart of a test measurement signal relay process at the relay device 40. The relay process is performed when a controller 401 (FIG. 7) of the relay device 40 executes a program stored in a memory function unit 406. The relay process starts when the relay device 40 receives the test measurement signal at communication function unit 404.

In FIG. 15, first, the controller 401 refers to a counter value field in the payload of the test measurement signal to set the variable “i” value as a value indicated by the counter value (S101).

Next, the controller 401 adds 1 to the variable “i” value (S102)

Next, the controller 401 set the counter value of the test measurement signal as the variable “i” value (S103).

Next, the controller 401 judges whether the variable “i” value meets the following condition (S104)
“Value of test measurement signal start counter=I=the value of test measurement signal start counter+L”

At this time, when the variable “i” value meets the condition, (“test measurement signal”. [StartCounter]=i=“test measurement signal”. [StartCounter]+L), the controller 401 sets the current time obtained form the clock function unit 405 in the field of the timestamp corresponding to the current “in value ([TineStamp#i]) (S105). Then, the process proceeds to S106.

On the other hand, when the value of the variable “i” does not meet the condition (S104; NO), the process proceeds to S106. That is, the timestamp is not set because there is no field for setting the timestamp in the test measurement signal by the relay device 40.

In S106, the controller 401 transmits the test measurement signal from the communication function unit 404 toward the reception device 30. Then, the relay process ends.

<Test Measurement Signal Reception Process>

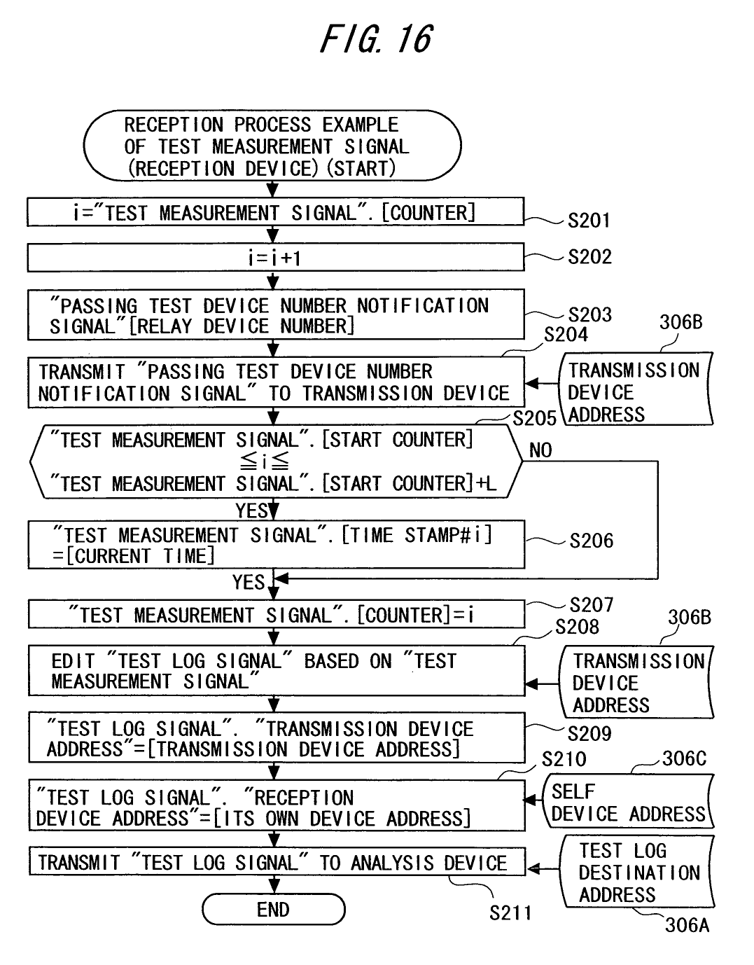

FIG. 16 is a flowchart of a test measurement signal reception process example at the reception device 30. The reception process is performed when the controller 301 (FIG. 6) of the reception device 30 executes a program stored in the memory function unit 306. The reception process starts when the reception device 30 receives the test measurement signal at the designated reception port of the communication function unit 304.

In FIG. 16, first, the controller 301 sets the variable “i” value as the value stored in the counter field of the test measurement signal (S201).

Next, the controller 301 adds 1 to the variable“i” value (S202) Next, the controller 301 sets the variable “i” value in the relay device number field of the passing test device number passing signal (S203)

Next, the controller 301 reads out the transmission device address stored in the storage area 306B of memory function unit 306 to set in the passing test device number passing signal, and transmits it to the transmission device 20 from the communication function unit 304 (S204).

Next, the controller 301 judges whether the variable “i” value meets the following condition (S205).
“Value of test measurement signal start counter=i=the value of test measurement signal start counter+L”

At this time, when the variable “i” value meets the condition, (“test measurement signal”. [StartCounter]=i=“test measurement signal”. [StartCounter]+L), the controller 301 sets the current time obtained from the clock function unit 305 in the storage field of the timestamp corresponding to the current “i” value ([TineStamp#i]) (S206). Then, the process proceeds to S207.

On the other hand, the variable “i” value does not meet the condition (S205; NO), the process proceeds to S207. That is, the timestamp is not set because there is no field for setting the timestamp in the test measurement signal by the reception device 30.

In S207, the controller 301 sets the current variable “i” value in the counter field of the test measurement signal.

Next, the controller 301 edits the test log signal (FIG. 12) based on the test measurement signal (S208).

Next, the controller 301 reads out the transmission device address stored in the storage area 306B of the memory function unit 306, and sets it in the transmission device address field of the test log signal (S209).

Next, the controller 301 reads out its owndevice address stored in the storage area 306C of the memory function unit 306, and sets it in the reception device address field of the test log signal (S210).

Finally, the controller 301 reads out the test log notification destination address stored in the storage area 306A of the memory function unit 306, and sets it in the test log signal, and transmits it to the analysis device 10 from the communication function unit 304 (S211). Then, the process ends.

<Measurement Log Table Structure>

FIG. 17 shows a structure example of the measurement log table 106a stored in the storage area 106A of the storage function unit 106 of the analysis device 10. As shown in FIG. 17, the measurement log table 106a is composed of plural records including items of “transmission device address”, “reception device address”, “sequence number (SQN)”, “counter (Counter)”, “startcounter (StartCounter)”, and “timestamps #0 to #L (TimeStamp#0-#L)”.

Fields of “transmission device address”, “reception device address”, “SQN”, “Counter”, “StartCounter”, and “TimeStamp” included in the measurement log table 106a are used for setting (storing) [the transmission device address], [the reception device address], [SQN], [Counter], [StartCounter], and [TimeStamp] included in the test log signal, respectively, in the table 106A.

The controller 101 of the analysis device 10 writes information included in the test log signal, in the measurement log table 106a, when the communication function unit 304 receives the test log signal from the reception device 30.

Note that, in FIG. 17, the address “A” of the transmission device 20 is stored as the transmission device address, the address “B” of the reception device 30 is stored as the reception device address. The value “0” to “m” according to the test measurement signal transmission number is stored as a sequence number. “n+1” obtained by adding the reception device 30 to the relay devices 40 is stored as a counter value. The value indicating “0(k=0)”, “L(k=1)”, “k*L(k=2,3, . . . )” is stored as the start counter value. Then, the transmission time of the transmission device 20, the passing times of the relay devices 40, and the reception time of the reception device 30 are respectively stored as the timestamp.

<Fluctuation Calculation Table>

FIG. 18 shows a structure example of a fluctuation calculation table 106b stored in the storage area 106B of the storage function unit 106 of the analysis device 10. As shown in FIG. 18, the fluctuation calculation table 106b has areas for storing items of “transmission device address”, “reception device address”, “time ID”, “section ID”, and “fluctuation amount”, and stores plural records including those items.

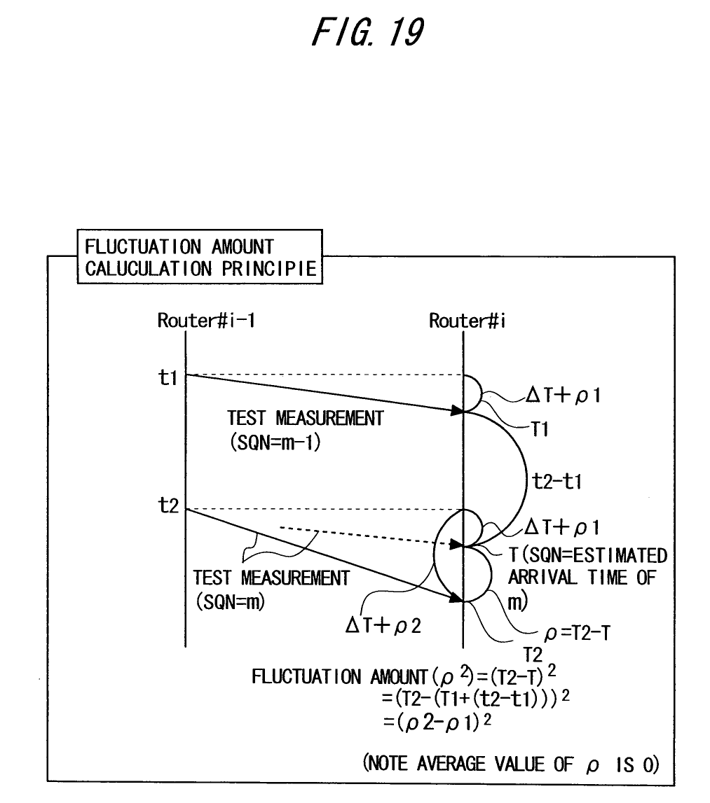

Here, “transmission device address” is the address of the transmission device 20 and used for identifying the transmission device 20 that is the source of the test measurement signal. “Reception device address” is the address of the reception device 30 and used for identifying the reception device 30 that is the destination of the test measurement signal. The time ID is identification information of a time interval for specifying a time interval corresponding to a transmission interval between one test measurement signal and the immediately preceding test measurement signal. The section ID is identification information for identifying a relay section between one relay device 40 (or reception device 30) and the immediately preceding relay device 40 (or transmission device 20) and is used for identifying the relay section. “Fluctuation amount” is the fluctuation amount corresponding to the time ID and the section ID. The fluctuation amount is a calculation result obtained based on the calculation principle shown in FIG. 19.

<Fluctuation Amount Calculation Principle>

FIG. 19 is an explanatory diagram of the fluctuation amount calculation principle. FIG. 19 shows a case where the fluctuation amount between the router #i-1 and the router #i is calculated. In FIG. 19, [t1] is the transmission time of “test measurement signal (SQN=m-1)” at the router #i-1. [t2] is the transmission time of “test measurement signal (SQN=m)” at the router #i-1. [T1] is the reception time of “test measurement signal (SQN=m-1)” at the router #i. [T2] is the reception time of “test measurement signal (SQN=m)” at the router #i.

Further, [T] is a reception expectation time (arrival expectation time) at the router #i when assuming that “test measurement signal (SQN=m)” is delayed as late as “test measurement signal (SQN=m-1)”. [ρ] is the fluctuation amount of “test measurement signal (SQN=m)” with “test measurement signal (SQN=m-1)” as the reference and is the time difference between [T2] and [T].

Further, [ΔT] is an average arrival delay time of the test measurement signal from the router #i-1 to the router #i. [ρ1] is an arrival delay fluctuation time of “test measurement signal (SQN=m-1)”. [ρ2] is an arrival delay fluctuation time of “test measurement signal (SQN=m)”.

Here, “ρ=ρ2−ρ1”, and therefore “ρ=T2−T=T2−T1+t1−t2”, so “fluctuation amount” can be evaluated (calculated).

<Fluctuation Calculation Process>

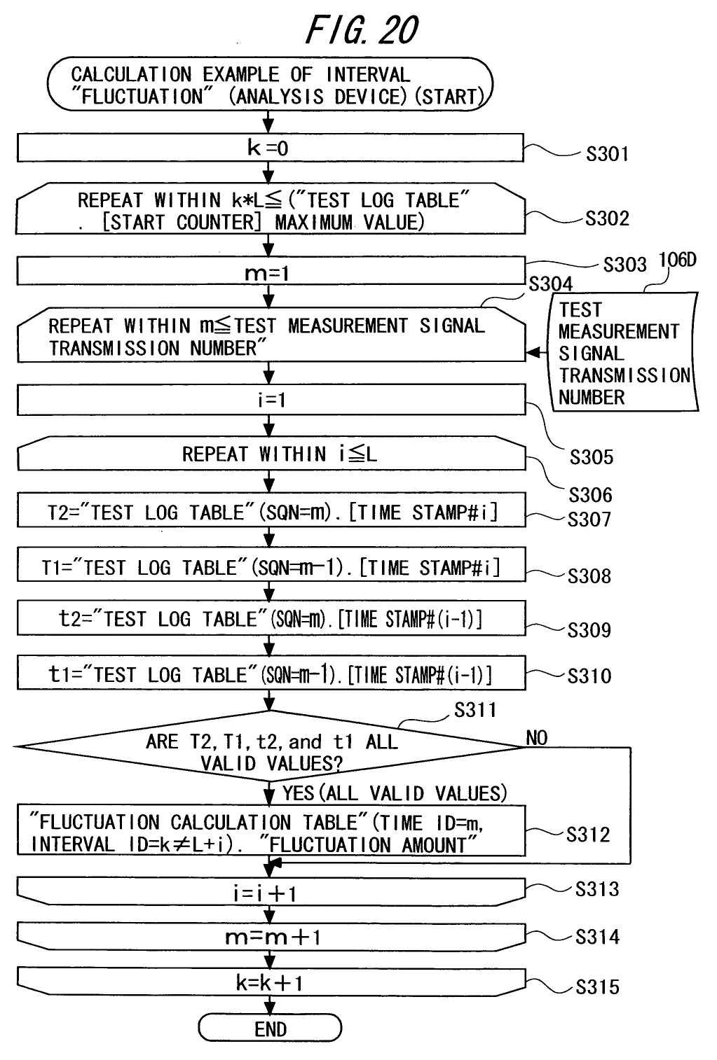

FIG. 20 is a flowchart of a fluctuation amount calculation process example in each section by the analysis device 10. FIG. 20 shows the process of calculating the fluctuation amount in records of the transmission device address “A” and the reception device address “B” as shown in FIG. 18. The calculation process is performed when the controller 101 of the analysis device 10 (FIG. 4) executes the program. In addition, the calculation process starts after the measurement sequence (test) between the transmission device 20 and the reception device 30 ends as shown in FIG. 3 and the analysis device 10 creates the test log table 106a (FIG. 17) based on the test.

In FIG. 20, first, the controller 101 sets the variable “k” value as 0 (S301).

Next, the controller 101 judges whether or not the condition “k*L=(maximum value of the start counter of the test log table 106a)” is met (S302), and until the condition is met, the following process of S303 to S315 is repeatedly performed. On the other hand, when the condition is not met, the controller 101 finishes the fluctuation calculation process.

In S303, the controller 101 sets the variable “m” value as 1 (S303).

Next, the controller 101 reads out a test measurement signal transmission number 106D from the storage function unit 106 and judges whether or not the condition “m=test measurement signal transmission number” is met (S304). Until the condition is met, the following process of S305 to S314 is repeatedly performed.

In S305, the controller 101 sets the variable “i” value as 1.

Next, the controller 101 judges whether or not the condition “i=L” is met (S306), and until the condition is met, the following process of S307 to S313 is repeatedly performed.

In S307, the controller 101 has the sequence number (SQN) corresponding to the current variable “m” value as the “T2” value defined based on the principle, and obtains the timestamp of the device (the relay device 40 or the reception device 30) corresponding to the current variable “i” value from the test log table 106a.

Next, the controller 101 has the sequence number corresponding to the value obtained by subtracting 1 from the current variable “m” as the “T1” value defined based on the principle, and obtains the timestamp of the device (the relay device 40 or the reception device 30) corresponding to the current variable “i” value from the test log table 106a (S308).

Next, the controller 101 has the sequence number (SQN) corresponding to the current variable “m” value as the “t2” value defined based on the principle, and obtains the timestamp of the device (the relay device 40 or the transmission device 20) corresponding to the value obtained by subtracting 1 from the current variable “i” value from the test log table 106a.

Next, the controller 101 has the sequence number corresponding to the value obtained by subtracting 1 from the current variable “m” as the “t1” value defined based on the principle, and obtains the timestamp of the device (the relay device 40 or the transmission device 20) corresponding to the value obtained by subtracting 1 from the current variable “i” value from the test log table 106a (S308).

Next, the controller 101 judges whether or not each value of “T2”, “T1”, “t2”, and “t1” is a valid value (S311). At this time, when all the vales are valid values (S311; YES), the process proceeds to S312, and when not (S311; NO), the process proceeds to S313.

In S312, the controller 101 sets (stores) the current variable “m” value as the time ID in the records of the transmission device address “A” and the reception device address “B” of the fluctuation calculation table 106b (FIG. 18), and sets (stores) the value obtained by adding the current “i” to the current “k*L” as the section ID. Further, the controller 101 calculates the fluctuation amount by assigning the values of “T2”, “T1”, “t2”, and “t1” obtained in S307 to S310 to a fluctuation amount calculation formula” (T2−T1−t2+t1)²”, to set (store) it in the corresponding record.

In S313, the controller 101 adds 1 to the variable “i” value and returns the process to S306. When the condition “i=L” is not met in S305, the controller 101 adds 1 to the variable “m” (S314) and returns the process to S304. When the condition is not met in S304, the controller 101 adds 1 to the variable “k” (S315) and returns the process to S302.

As described above, the fluctuation amount in each section is calculated based on the principle shown in FIG. 19. Therefore, times obtained from the clock function unit between the respective devices corresponding to the start point and the end point of the section need not set to each other.

<Structure of Fluctuation Amount Calculation Result Table>

FIG. 21 shows a structure example of the fluctuation amount calculation result table 106c created in the storage area 106C of the storage function unit 106 of the analysis device 10. The fluctuation amount calculation result table 106c is structured to hold plural records including each item of “transmission device address”, “reception device address”, “section ID” and “average fluctuation amount”, and have a field for storing an item for each record.

37 Transmission device address” is the address of the test-target transmission device 20 and is used for identifying the transmission device 20 that is the source of the test measurement signal. “Reception device address” is the address of the test-target reception device 30 and is used for identifying the reception device 30 that is the destination of the test measurement signal. “Section ID” is used for identifying a relay section between a relay device 40 (or reception device 30) and the immediately preceding relay device 40 (or transmission device 20) . “Average fluctuation amount” is an average value of “fluctuation amounts” stored in the fluctuation calculation table 106b (FIG. 18) corresponding to “section ID”.

Writing process for each item in the fluctuation amount calculation result table 106c starts after the controller 101 finishes the above-mentioned fluctuation calculation process (FIG. 20). The controller 101 can rearrange automatically or through an instruction from the input function unit 102 records stored in the fluctuation calculation result table 106c in “average fluctuation amount” descending order. Accordingly, the plural records are sorted in voice degradation descending order.

The controller 101 displays storage contents (plural records) in the fluctuation calculation result table on a display screen of the display function unit 103. Accordingly, “average fluctuation amounts” of respective sections constituting test-target voice paths between the transmission device 20 and the reception device 30 can be presented to a user of the analysis device 10 (for example, a network administrator) in section order or fluctuation amount average descending order.

<Passing Test Device Number Notification Signal Reception Process>

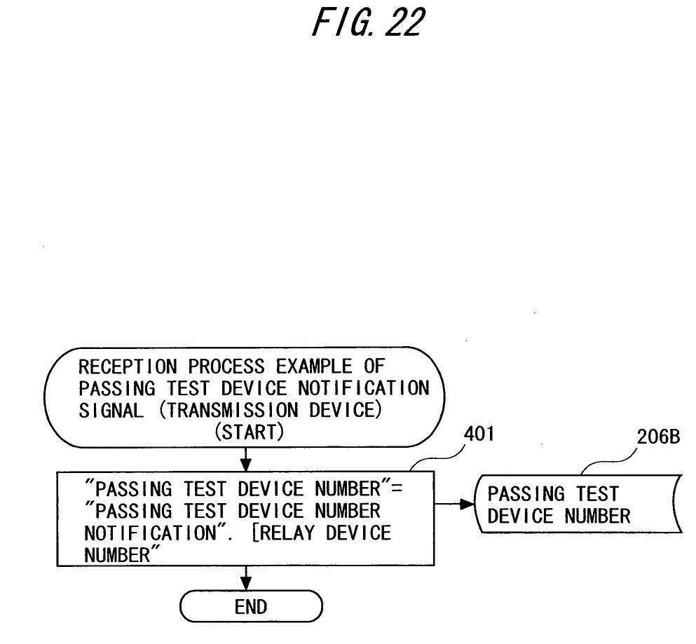

FIG. 22 is a flowchart of a reception process example of the passing test device number notification signal by the transmission device 20. The reception process is performed when the controller 201 (FIG. 5) of the transmission device 20 executes the program. Then, the reception process starts when the transmission device 20 receives the passing test device number notification signal (FIG. 13) from the reception device 30 at the communication function unit 204.

In FIG. 22, the controller 201 receives the passing test device number notification from the communication function unit 204 and then sets (overwrites) the relay device number included therein in the storage area 206B of the storage function unit 206 as “passing test device number” (S401). Then, the reception process ends.

<Test Start Instruction Signal Transmission Process>

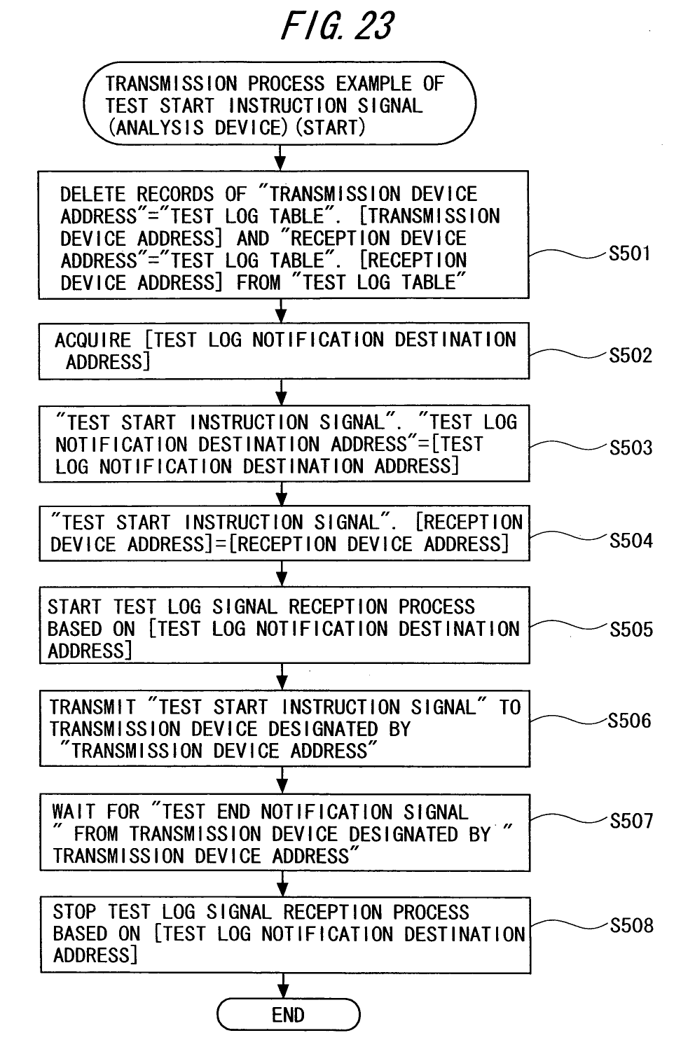

FIG. 23 is a flowchart of a transmission process example of the test start instruction signal by the analysis device 10 (FIG. 9). The transmission process is performed when the controller 101 of the analysis device 10 (FIG. 4) executes the program. The transmission process starts when, for example, the controller 101 receives the transmission device address and the reception device address input (designated) by the input function unit 102 as input parameters.

In FIG. 23, first, the controller 101 deletes from the test log table 106a (FIG. 17), records to which the same addresses as the transmission device address and the reception device address are set as input parameters (S501).

Next, the controller 101 acquires the test log notification destination address (S502). In this case, the controller 101 may automatically acquire the predetermined test log notification destination address among plural test log notification destination addresses previously stored in the storage area 106G of the storage function unit 106 or may acquire the test log notification destination address input or designated by the input function unit 102.

Next, the controller 101 sets the test log notification destination address acquired in S502 in the test log notification destination address field of the test start instruction signal (S503).

Next, the controller 101 reads out the reception device address stored in the storage function unit 106, and sets it in the reception device address field of the test start instruction signal (S504).

Next, the controller 101 starts the test log signal reception process based on the test log notification destination address (S505).

Next, the controller 101 transmits the test start instruction signal to the transmission device 20 designated by the transmission device address as the input parameter from the communication function unit 106 (S506). At this time, the transmission device address is set in storage area 106E.

Next, the controller 101 receives a test end notification signal from the transmission device 20 designated by the transmission device address (S507).

Finally, the controller 101 receives the test end notification signal and then stops the test log signal reception process based on a test log notification destination address 106G (S508), and the process ends.

<Test Start Instruction Signal Reception Process>

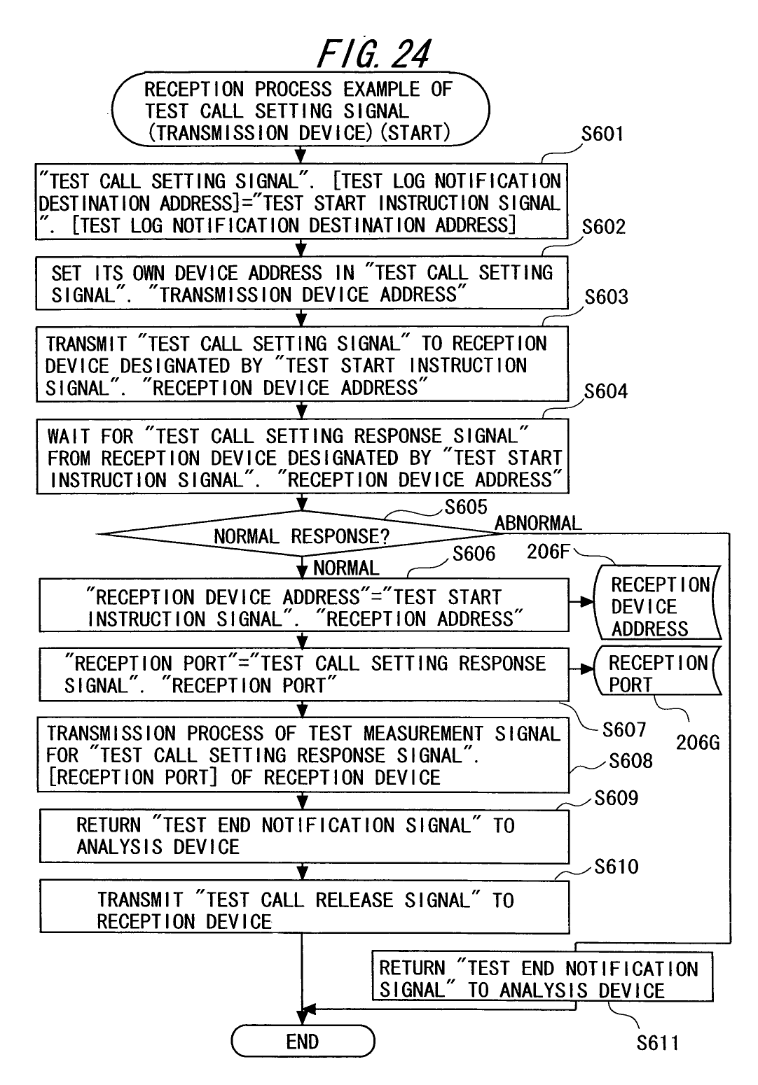

FIG. 24 shows a test start instruction signal reception process example by the transmission device 20. The process is performed when the controller 201 (FIG. 5) of the transmission device 20 executes the program stored in the storage function unit 206. The process starts when the communication function unit 204 of the transmission device 20 receives the test start instruction signal from the analysis device 10 and the controller 201 receives the test start instruction from the communication function unit 204.

In FIG. 24, first, the controller 201 sets the test log notification destination address (FIG. 9) in the test call setting signal, in the test log notification destination address field of the test call setting signal (FIG. 10) (S601).

Next, the controller 201 reads out its own device address stored in the storage area 206E of the storage function unit 206, and sets it in the transmission device address field of the test call setting signal (S602).

Next, the controller 201 sets the reception device 30 designated by the reception device address in the test start instruction signal as the destination to transmit the test call setting signal (S603). The test call setting signal is transmitted from the communication function unit 204 toward the destination reception device 30.

Next, the controller 201 waits for the test call setting response signal from the reception device 30 designated by the reception device address of the test start instruction signal (S604).

Then, the controller 201 judges whether a response to the test call setting signal is normal or not (S605). That is, in the waiting state, the controller 201 judges that the response is “normal” when receiving a test call setting response signal and judges that the response is “abnormal” when receiving a test call setting abnormal response signal. When the response is normal, the process proceeds to S606, and when the response is abnormal, the process proceeds to S611.

Note that the judgment process in S605 may be performed as follows. That is, the controller 201 when transmitting the test call setting signal starts count of a timer (not shown) for standing by to receive for the test call setting response signal (FIG. 11). Before the timer times out, when the test call setting response signal has been received, the controller judges that the response is normal, and when not (the test call setting response signal has not been received before the timeout), the controller judges that the response is abnormal (S605; abnormal). With this structure, the reception device 30 does not need to transmit the test call setting abnormal response signal. Alternatively, the controller may receive the abnormal signal or judge that it is abnormal based on the timeout while the above timeout process is simultaneously performed with transmission/reception of the test call setting response/abnormal signal.

When the process proceeds to S606, the controller 201 sets the value of the reception device address designated by test start instruction signal, in the storage area 206F of the storage function unit 206.

Next, the controller 201 sets the reception port number included in the test call setting response signal, in the storage area 206G of the storage function unit 206 (S607).

Next, the controller 201 performs the test measurement signal transmission process toward the reception port designated by the test call setting response signal from the reception device 30 (FIG. 14) (S608).

When finishing the test measurement signal transmission process, the controller 201 creates a test end notification signal and transmits it to the analysis device 10 via the communication function unit 206 (S609).

Finally, the controller 201 creates a test call release signal, transmits it to the reception device 30 via the communication function unit 206 (S610), and finishes the process.

Incidentally, when judging that it is “abnormal” in S605, the controller 201 creates a test abnormal end notification signal, transmits it to the analysis device 10 via the communication function unit 206 (S611), and finishes the process.

<Test Call Setting Signal Reception Process>

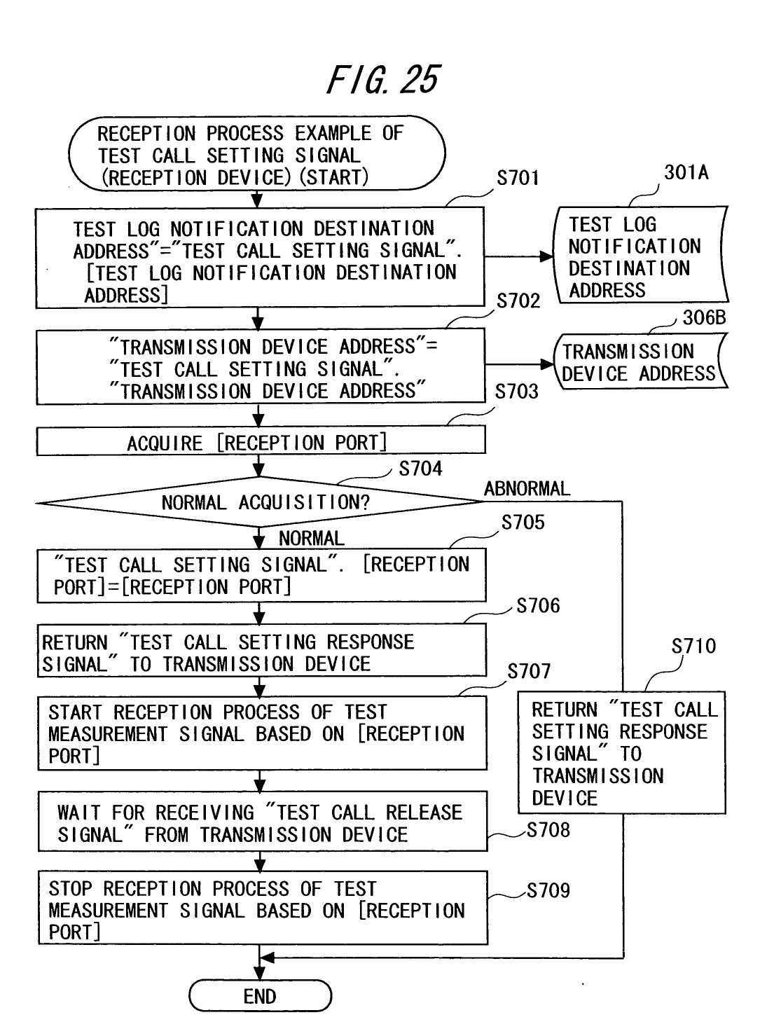

FIG. 25 is a flowchart of a test call setting signal reception process example by the reception device 30. The process is performed when the controller 301 of the reception device 30 executes the program stored in the memory function unit 306. The process starts when the reception device 30 receives the test call setting signal from the transmission device 20.

In FIG. 25, first, the controller 301 sets the value of the test log notification destination address in the test call setting signal (FIG. 10), in the storage area 306A of the memory function unit 306 (S701)

Next, the controller 301 sets the value the transmission device address in the test call setting signal, in the storage area 306B of the memory function unit 306 (S702).

Next, the controller 301 acquires the reception port used for receiving the test measurement signal (S703) and judges whether the acquisition is normal or not (S704). When the acquisition is normal (S704; normal), the process proceeds to S705, and when not (S704; abnormal) the process proceeds to S710.

In S705, the controller 301 sets the reception port number of the reception port normally acquired, in the reception port field of the test call setting response signal (FIG. 11) and also in the storage area 306D of the memory function unit 306.

Next, the controller 301 transmits the test call setting response signal to the transmission device 20 that is the destination of the test call setting signal (S706).

Next, the controller 301 starts the test measurement signal reception process (FIG. 16) by the reception port normally acquired in S703 (S707).

On the other hand, the controller 301 stands by to receive the test call release signal from the transmission device 20 (S708).

When receiving the test call release signal, the controller 301 stops the test measurement signal reception process (S709) and finishes the process.

Incidentally, when judging that the acquisition of the reception port is abnormal (S704; abnormal), the controller 301 creates a test call setting abnormal response signal, transmits it to the transmission device 20 (S710), and finishes the process.

<Test Log Signal Reception Process>

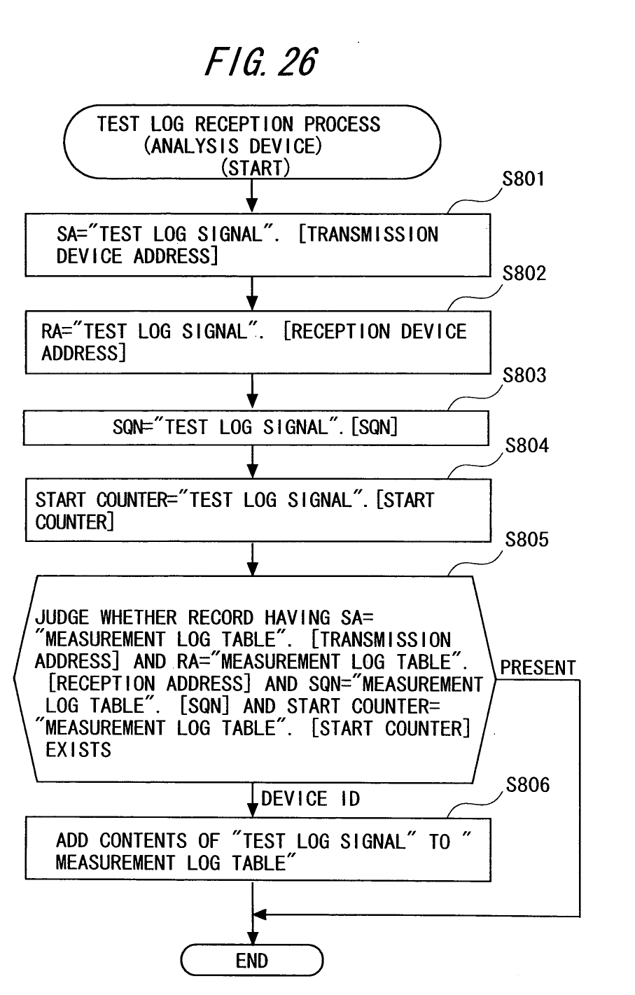

FIG. 26 is a flowchart of a test log signal reception process example by the analysis device 10. The process is performed when the controller 101 of the analysis device 10 executes the program. In the test start instruction signal transmission process (FIG. 23), the process starts after the process in S504 ends, and stops when receiving the test end signal. The process shown in FIG. 26 is performed each time the test log signal (FIG. 12) is received.

In FIG. 26, first, the controller 101 sets a variable “SA” value as the transmission device address value included in the test log signal received by the reception device 30 (S801).

Next, the controller 101 sets a variable “RA” value as the reception device address value in the test log signal (S802).

Next, the controller 101 sets a variable “SQN” value as the sequence number (SQN) value in the test log signal (S803).

Next, the controller 101 sets a variable “StartCounter” value as the start counter [StartCounter] value in the test log signal (S804).

Next, the controller 101 judges whether records having the same values as the above variable values of “SA”, “RA”, “SQN”, and “StartCounter” in the measurement log table 106a (FIG. 17) exist or not (S805). At this time, when corresponding records exist, the process ends, and when corresponding records do not exist, the controller 101 adds contents of the test log signal to the test log table 106a (S806), and finishes the process.

<Case of Identifying Passing Devices>

According to the above embodiment, identification information of the devices for performing transmission, reception, and relay of the test measurement signal, respectively (the transmission device 20, the reception device 30, and the relay devices 40: collectively referred to as “passing device”) is not notified to the analysis device 10. On the other hand, when identification information of the passing devices (case of identifying passing devices) is notified, the following structure is adopted.

On the assumption, the transmission device 20, the relay devices 40, and the reception device 30 for performing transmission, relay, and reception of the test measurement signal, store identifier of each device (the transmission device 20, the relay devices 40, and the reception device 30) in the corresponding storage function units 206, 306, and 406, respectively. The identifier of the devices is used as device IDs.

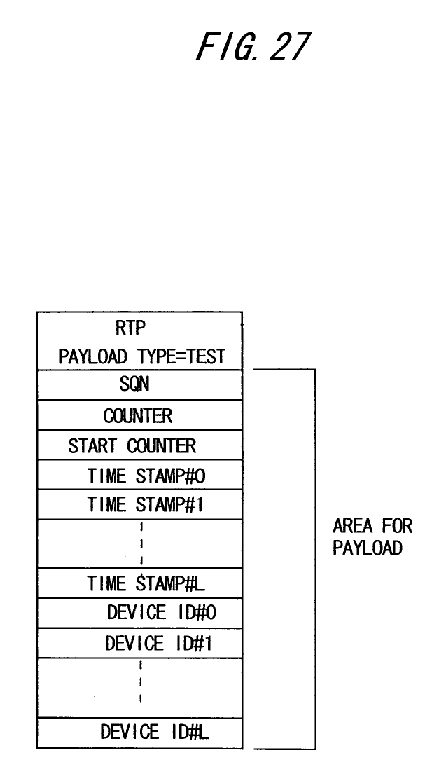

FIG. 27 shows a field structure example of the test measurement signal when passing devices are identified. In FIG. 27, “SQN”, “Counter”, “TimeStamp”, “StartCounter” are the same information as the test measurement signal shown in FIG. 8. “Device ID” is identification information of the passing device, and is used for specifying passing devices dealing with the test measurement signal. The device ID setting position of each relay device 40 is specified by respective values of “StartCounter” and “Counter”. In the example shown in FIG. 27, plural storage fields of the device IDs (device ID #0 to #L) corresponding to the timestamp storage fields are prepared on a one-on-one basis. With the same method as the above method of specifying the timestamp storage position, the device ID storage position is specified.

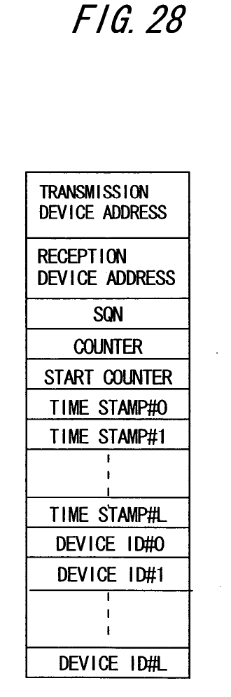

FIG. 28 shows a field structure example of the test log signal when the passing devices are identified. In FIG. 28, “transmission device address”, “reception device address”, “SQN”, “Counter”, “StartCounter”, and “TimeStamp” are the same as the test log signal shown in FIG. 12. “Device ID” corresponds to the device ID set in the test measurement signal, and is set for notifying the analysis device 10 of the device ID obtained by the test measurement signal.

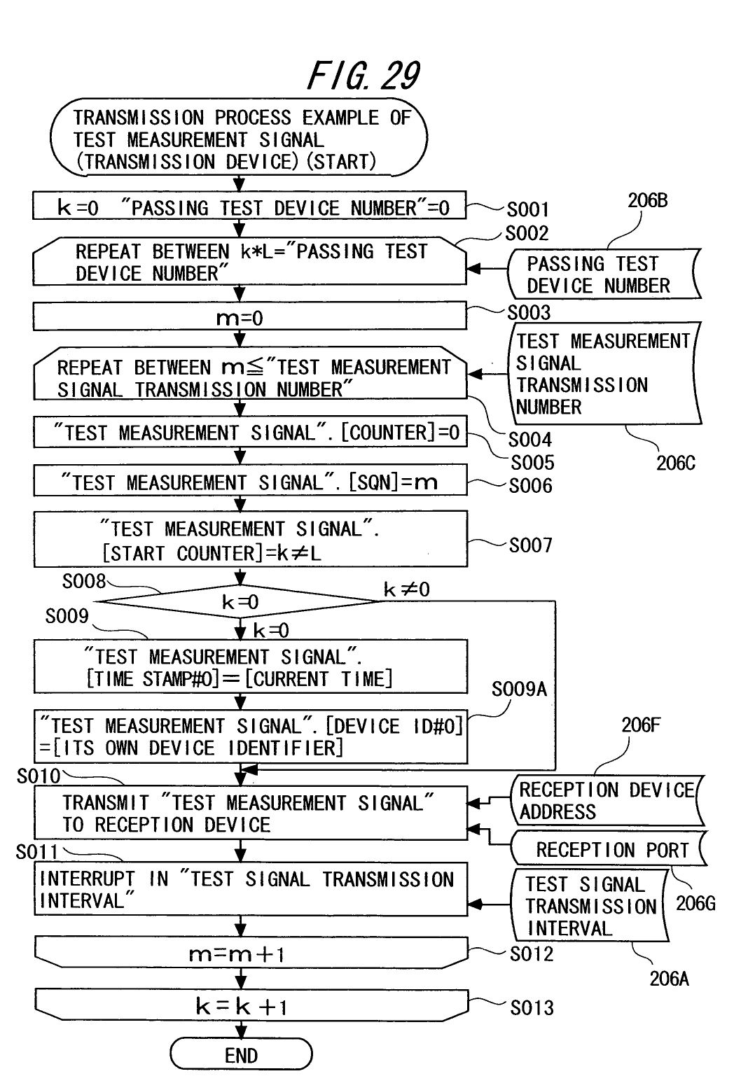

FIG. 29 is a flowchart of the test measurement signal transmission process by the transmission device 20 when the passing devices are identified. The process shown in FIG. 29 is the same as the process of FIG. 14 expect that the process of S009A is inserted between S009 and S010 of the flowchart shown in FIG. 14.

In S009A, the controller 201 sets its own identifier in the device ID#0 field of the test measurement signal (FIG. 27). Accordingly, identification information of the transmission device 20 is given to the test measurement signal transmitted from the transmission device 20.

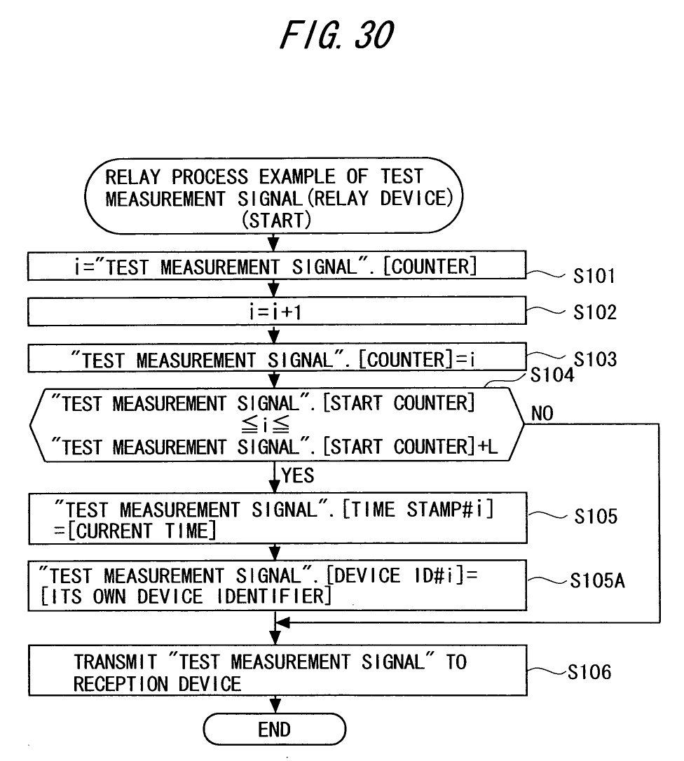

FIG. 30 is a flowchart of the test measurement signal relay process by the relay devices 40 when the passing devices are identified. The process shown in FIG. 30 is the same as the process of FIG. 15 expect that the process of S105A is inserted between S105 and S106 of the flowchart shown in FIG. 15.

In S105A, the controller 401 sets its own identifier in the “device ID #i” field of the test measurement signal (FIG. 27). Accordingly, identification information of the relay devices 40 is given to the test measurement signal passing through the relay devices 40.

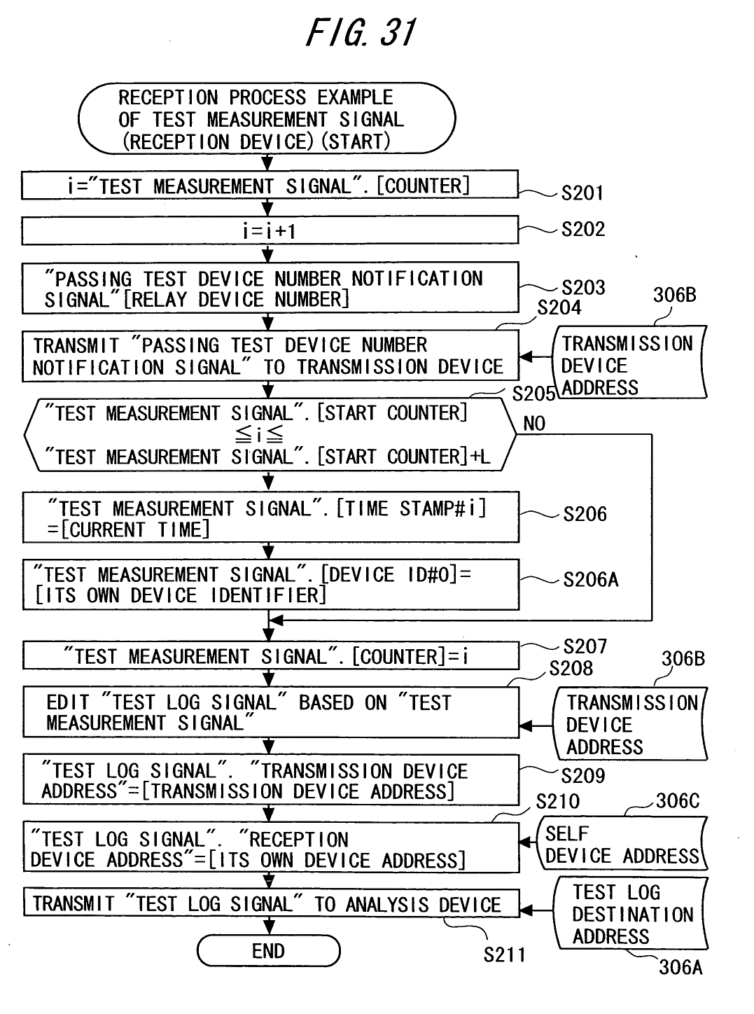

FIG. 31 is a flowchart of the test measurement signal reception process by the reception device 30 when the passing devices are identified. The process shown in FIG. 31 is the same as the process of FIG. 16 expect that the process of S206A is inserted between S206 and S207 of the flowchart shown in FIG. 16.

In S206A, the controller 301 sets its own identifier in the “device ID #i” field of the test measurement signal (FIG. 27). Accordingly, identification information of the reception device 30 is given to the test measurement signal received by the reception device 30.

When the reception process shown in FIG. 31 ends, the test log signal to which the storage contents of the test measurement signal are set are transmitted to the analysis device 10, and at the analysis device 10, the measurement log table 106a based on the test log signal is created.

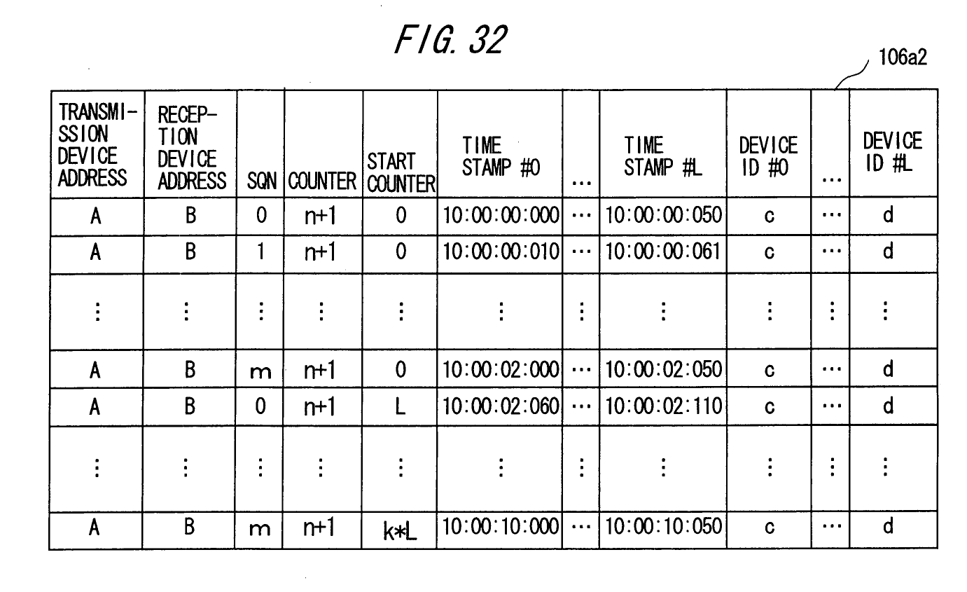

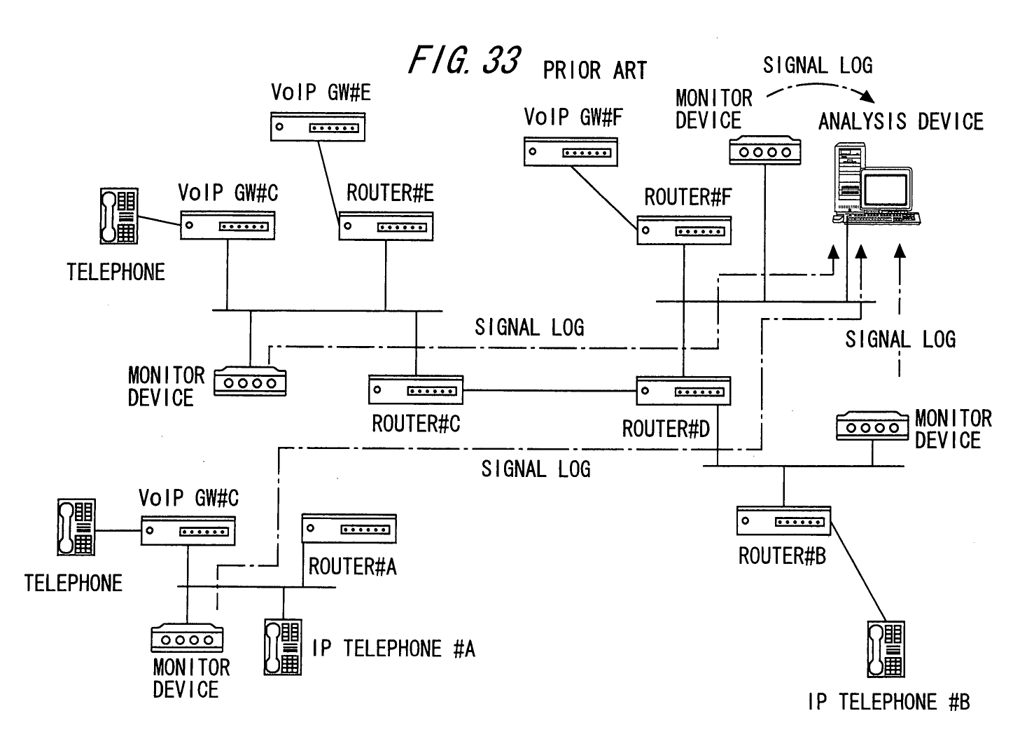

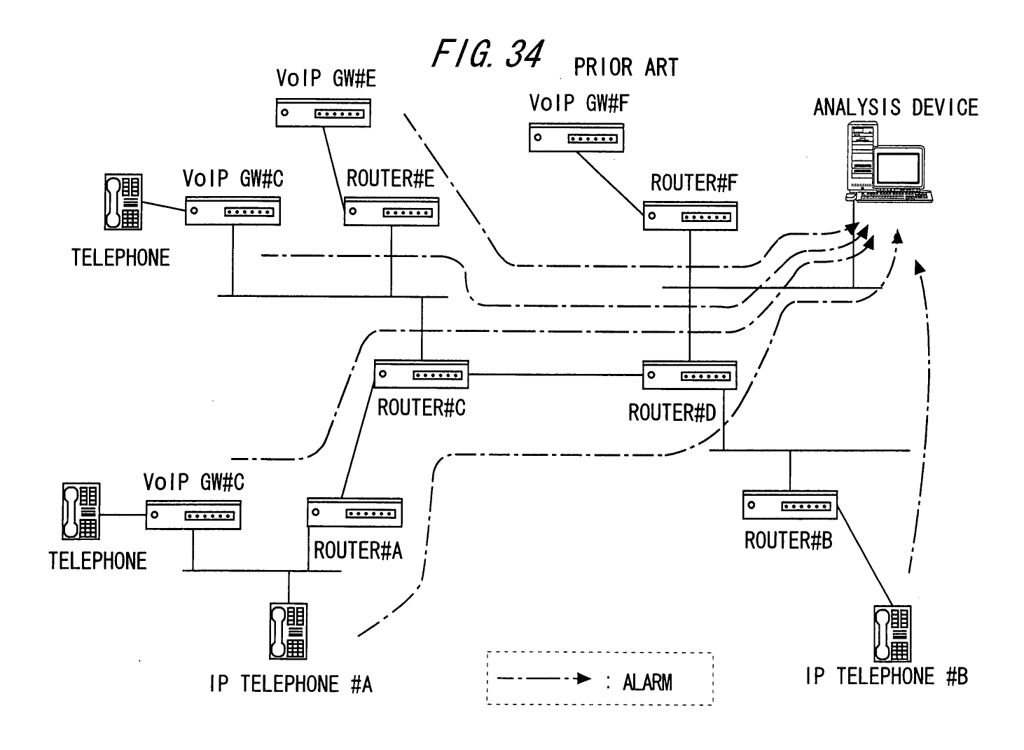

FIG. 32 shows a structure example of a measurement log table 106a2 when the passing devices are identified. In the measurement log table 106a2, [the transmission device address], [the reception device address], [SQN], [Counter], [StartCounter], and [TimeStamp] have the same structure as the measurement log table 106a shown in FIG. 17. On the other hand, fields for each setting corresponding [device ID] stored in the test log signal are prepared in the measurement log table 106a2.

In this way, identification information of each test measurement signal passing device (the transmission device 20, the relay devices 40, and the reception device 30) is notified to the analysis device 10, and set in the test log table 106a2. Thus, the analysis device 10 can specify the passing devices corresponding to the start point and the end point of each section in the voice paths.

Therefore, in calculation of the fluctuation amount of each section (creation of the fluctuation amount calculation result table 106c), while corresponding to the section ID, it is possible to create the fluctuation amount calculation result table in which the device IDs corresponding to the start point and the end point of the section are set. Accordingly, when a section with the large fluctuation amount, that is, a section with the voice quality degradation is specified using the fluctuation amount calculation result table, the passing devices corresponding to the start point and the end point of the section can be specified and recognized.

<Operation Example>

Next, Operation Example 1 of the above-mentioned system is described.

In the system shown in FIG. 1, based on the predetermined test schedule, a claim from an IP telephone user, an alarm notification from the VOIP gateway, etc., an analysis start instruction is issued to the analysis device 10 externally through a manual operation of the user, for example. Alternatively, the analysis device 10 automatically starts the analysis according to the above-mentioned schedule, claim, or alarm notification.

Then, the analysis device 10 executes “test start instruction signal transmission process (FIG. 23)” to transmit the test start instruction signal (FIG. 9) to the transmission device 20 as shown in FIG. 3, and waits for the test end notification signal from the transmission device 20.

When receiving the test start instruction signal, the transmission device 20 executes “test start instruction signal reception process (FIG. 24)”, to transmits the test call setting signal (FIG. 10) to the reception device 30 as shown in FIG. 3, and waits for the test call setting response signal (FIG. 11) from the reception device 30.

When receiving the test call setting signal, the reception device 30 executes “test call setting signal reception process (FIG. 25)”, and transmits the test call setting response signal to the transmission device 20 as shown in FIG. 3. Then, the reception device 30 starts reception of the test measurement signal (FIG. 8) from the transmission device 20 and waits for the test call release signal.

When receiving the test call setting response signal from the reception device 30, the transmission device 20 returns from the reception waiting state for the test call setting response signal in “test start instruction signal reception process (FIG. 24)”, executes “test measurement signal transmission process (FIG. 14)”, and transmits the test measurement signal to the reception device 30 as shown in FIG. 3.

When receiving the test measurement signal, the relay device 40 executes “test measurement signal relay process (FIG. 15)”, and transmits the test measurement signal toward the reception device 30 as shown in FIG. 3.

When receiving the test measurement signal, the reception device 30 executes “the test measurement signal reception process (FIG. 16)”, transmits the passing test device number notification signal (FIG. 13) to the transmission device 20, and transmits the test log signal (FIG. 12) toward the analysis device 10 as shown in FIG. 3.

When receiving the passing test device number notification signal from the reception device 30, the transmission device 20 executes “reception process of the passing test device number notification signal (FIG. 22)” and changes the value of the passing test device number (value of the area 206B; FIG. 5).

Thus, the passing test device number referred to in “test measurement signal transmission process (FIG. 14)” is changed. Therefore, as shown in FIG. 3, transmission of the test measurement signal toward the reception device 30 is repeated as necessary.

When receiving the test log signal from the reception device 30, the analysis device 10 executes “test log signal reception process (FIG. 26)” and accumulates data in the test log table 106a (FIG. 17).

After executing “test measurement signal transmission process (FIG. 14)”, the transmission device 20 returns to the process of “test start instruction signal reception process (FIG. 24)”. Then, as shown in FIG. 3, the transmission device 20 transmits the test end notification signal toward the analysis device 10 and also transmits the test call release signal toward the reception device 30.

When receiving the test call release signal, the reception device 30 returns from the reception waiting state for the test call release signal in “test call setting signal reception process (FIG. 25)” and stops “test measurement signal reception process”.

When receiving the test end notification signal from the transmission device 20, the analysis device 10 returns from the reception waiting state for the test end notification signal in “test start instruction signal transmission process (FIG. 23)” and stops “test log signal reception process”.

The analysis device 10 executes “section fluctuation calculation process (FIG. 20)” and processes data stored in the measurement logtable 106a (FIG. 17) into the fluctuation calculation table 106b (FIG. 18). Further, the analysis device 10 calculates the average value of the fluctuation amounts in the fluctuation calculation table 106b corresponding to “section ID” and processes it into “fluctuation calculation result table 106c.

The analysis device 10 can output contents of the fluctuation calculation result table 106c from the display function unit 103. The network administrator can specify a “defective section” assumed to cause voice quality degradation based on the test result indicated by the storage contents in the fluctuation calculation result table 106c. Then, the network administrator can perform detour of the “defective section” by switching, replacement, and path switching of the devices relating to the “defective section” through a manual operation, for example. Also, such structure can be adopted that the above operation (path switching, etc.) relating to the detour of the “defective section” is automatically performed based on the instruction from the analysis device 10.

An operation example when the passing devices are identified is the same as the above-mentioned operation example except employing the test measurement signal shown in FIG. 27, the test log signal shown in FIG. 28, the test measurement signal transmission process shown in FIG. 29, the test measurement signal relay process shown in FIG. 30, the test measurement signal reception process shown in FIG. 31, and the test log table 106a2 shown in FIG. 32 instead of the test measurement signal shown in FIG. 8, the test log signal shown in FIG. 12, the test measurement signal transmission process shown in FIG. 14, the test measurement signal relay process shown in FIG. 15, the test measurement signal reception process shown in FIG. 16, and the test log table 106a shown in FIG. 17, respectively.

<Operation of Embodiments>

According to the above-mentioned system for specifying a quality degradation section in the communication path, timestamps (transmission time, passing time, and reception time) of the devices corresponding to the start point or the end point of the communication path are obtained by performing transmission/reception of the test measurement signal by the predetermined times between the transmission device 20 and the reception device 30 of the targeted communication path (voice path). Then, by using the timestamps obtained, the average value of the fluctuation amount in each section is obtained. Accordingly, a section having the average fluctuation amount assumed to cause communication quality (voice quality) degradation can be specified. Then, the detour process or process for improvement can be performed on the section.

According to the system of the embodiment, as in the prior art, it is unnecessary to install monitoring devices in all the sections through which a voice packet passes. Therefore, cost reduction can be achieved and the first problem described in the prior art can be solved.

Also, since it is not necessary to install the monitoring devices, the second and third problems described in the prior art can be solved.

Further, according to the system of the embodiment, the reception device transmits the test log signal to the analysis device. According to this structure, as compared with the prior art where the monitoring device corresponding to each section transmits the signal log signal to the analysis device, the number of signals (packets) to the analysis device can be reduced. Therefore, the network load can be reduced, and the fourth problem described in the prior art can be solved.

Further, the test is performed on the communication path unlike the prior art where the “defective section” is determined from alarms received by the reception device. Therefore, such situations do not occur that specification of the “defective section” becomes difficult because the number of alarms received by the reception device is small or the communication path has a deviation. Accordingly, the fifth and sixth problems described in the prior art can be solved.

Also, according to the system of the embodiment, even when the voice path goes via another carrier network and timestamps of relay devices on the other carrier network are not obtained, timestamps can be obtained from its own network. Accordingly, since whether at least its own network has the “defective section” or not can be judged, it is possible to specify where the “defective section” exists, in its own network or in the other network. Accordingly, the seventh problem described in the prior art can be solved.

Also, according to the system of the embodiment, no alarms are notified to the analysis device, alarm induction due to increase in alarm notifications does not occur. Therefore, unlike the prior art, it is not necessary to structure an additional network through which alarms pass. Accordingly, the eighth problem described in the prior art can be solved.

While rephrasing the advantage of the above-mentioned prior art, according to the system of the embodiment, the number of devices can be reduced as compared with the prior art. Also, the defective section can be specified with network load smaller than that of prior art.

Further, according to the system of the embodiment, based on the principle shown in FIG. 19, the fluctuation amount or the average value of fluctuation amounts is obtained as the quality index value. Therefore, for giving the timestamp (TimeStamp), devices dealing with “test measurement signal” do not need to synchronize “clock (time of the clock function unit)” among them.

However, such structure can be employed that the analysis device 10 etc. creates correction information for “clock (time of the clock function unit)” of each device, and the analysis device 10 corrects the value of [TimeStamp] of the measurement log tables 106a and 106a2 based on the correction information.

Further, the system of the embodiment is structured such that the IP telephones and the VOIP gateways have the functions of the transmission device 20 and the reception device 30, but routers can have the functions of the transmission device 20 and the reception device 30. Accordingly, even insections with small VoIP load, “test” can be performed for preventive maintenance.

Further, when the routers have the functions of the transmission device 20 and the reception device 30, transmission/reception of the test measurement signal is performed in sections with small VoIP load or during such period of time, making it possible to specify the “defective section” or guarantee the absence of the “defective section”.

Further, when the routers have the functions of the transmission device 20 and the reception device 30, in connection with another VOIP carrier or the like, it is possible to specify the “defective section” or guarantee the absence of the “defective section” in sections responsible for quality guarantee.

Further, other than VOIP, for example, “test” shown in FIG. 3 is performed in a device group for communication relay where importance is put on real-time characteristics (RTP, etc.), making it possible to specify the “defective section” or guarantee the absence of the “defective section”.

### INDUSTRIAL APPLICABILITY

The present invention is applicable to devices for performing transmission, relay, or reception of signals or packets on a communication path, or to a device or system for analyzing quality of a communication section structured between those devices.

For example, the present invention is applicable to IP telephones, VOIP gateway devices, router devices, and IP related communication devices for supporting communication putting importance on real-time characteristics (RTP, etc.).

[Others]

The disclosures of international application PCT/JP2003/009934 filed on Aug. 5, 2003 including the specification, drawings and abstract are incorporated herein by reference.

What is claimed is:

1. A system for analyzing quality of communication sections, comprising:
a transmission device transmitting a test measurement signal;
a reception device receiving the test measurement signal;
relay devices each located on a transmission path of the test measurement signal between the transmission device and the reception device, setting a relay time in the test measurement signal when relaying the test measurement signal toward the reception device; and
an analysis device including:
a reception unit receiving two or more relay time measurement results of the relay devices, each of which is obtained by the reception device when transmission/reception of the test measurement signal is performed two or more times by the transmission device and the reception device;
a calculation unit calculating a quality index value of a communication section between the relay devices based on the relay time measurement results; and
an output unit outputting the communication quality index value of the communication section.

2. The system for analyzing quality of communication sections according to claim 1, wherein:
the transmission device sets a transmission time in the test measurement signal;
the reception unit further receives two or more transmission time measurement results from the reception device; and
the calculation unit further calculates a quality index value of a communication section between the transmission device and one of the relay device located just behind the transmission device, based on the transmission time measurement results and the relay time measurement results.

3. The system for analyzing quality of communication sections according to claim 1, wherein:
the reception unit further receives two or more reception time measurement results of the test measurement signals received by the reception device, from the reception device; and
the calculation unit further calculates a quality index value of a communication section between the reception device and one of the relay devices located just before the reception device, based on the relay time measurement results and the reception time measurement results.

4. The system for analyzing quality of communication sections according to claim 1, wherein the calculation unit substitutes a relay time (T1) of a test measurement signal (m-1 (m is an integer)) in a relay device (i (i is an integer)), a relay time (t1) of the test measurement signal (m-1) in a relay device (i-1) located just before the relay device (i), a relay time (T2) of a next test measurement signal (m) in the relay device (i), and a relay time (t2) of the next test measurement signal (m) in the relay device (i-1) for the following formula:
(T2−T1−t2+t1)²
to calculate, as the index value, a fluctuation amount of a section between the relay device (i-1) and the relay device (i), or a fluctuation amount average value obtained from the fluctuation amounts calculated according to the number of times for performing the relay time measurement at the relay device (i-1) and the relay device (i).

5. The system for analyzing quality of communication sections according to claim 2, wherein the calculation unit substitutes a relay time (T1) of a test measurement signal (m-1 (m is an integer)) in a relay device (i (i is an integer)), a transmission time (t1) of the test measurement signal (m-1) in a transmission device (i-1) located just before the relay device (i), a relay time (T2) of a next test measurement signal (m) in the relay device (i), and a transmission time (t2) of the next test measurement signal (m) in the transmission device (i-1) for the following formula:
(T2−T1−t2+t1)²
to calculate as the index value a fluctuation amount of a section between the transmission device (i-1) and the relay device (i), or a fluctuation amount average value obtained from the fluctuation amounts calculated according to the number of times for performing the transmission time measurement at the transmission device (i-1) and the number of times for performing the relay time measurement at the relay device (i).

6. The system for analyzing quality of communication sections according to claim 1, wherein the calculation unit substitutes a reception time (T1) of a test measurement signal (m-1 (m is an integer)) in a reception device (i (i is an integer)), a relay time (t1) of the test measurement signal (m-1) in a relay device (i-1) located just before the reception device (i), a reception time (T2) of a next test measurement signal (m) in the reception device (i), and a relay time (t2) of the next test measurement signal (m) in the relay device (i-1) for the following formula:
(T2−T1−t2+t1)²
to calculate as the index value a fluctuation amount of a section between the relay device (i-1) and the reception device (i), or a fluctuation amount average value obtained from the fluctuation amounts calculated according to the number of times for performing the relay time measurement at the relay device (i-1) and the number of times for performing the reception time measurement at the reception device (i)

7. The system for analyzing quality of communication sections according to claim 1, wherein:
the transmission device performs by predetermined two or more times test processing for measuring any one of a transmission time, a relay time, and a reception time of the test measurement signal at devices corresponding to a start point and an end point of a test measurement signal communication section structured by any one of a section between the transmission device and the reception device, a section between the relay devices, and a section between the relay device and the reception device, in a section between the transmission device and the reception device; and
in the test processing, the transmission device
transmits toward the reception device the test measurement signal of the first time in which a transmission time at the transmission device is set,
there after receives from the reception device that has received the test measurement signal of the first time, a passing device number indicating the number of devices through which the test measurement signal of the first time passes,
judges based on the passing device number whether the relay times corresponding to all the communication sections are set or not in the test measurement signal of the first time, and when the relay times are set, starts the next test processing if the number of the test process does not reach the predetermined times and finishes the test processing if the number reaches the predetermined times, and
when the relay times corresponding to all the communication sections are not set in the test measurement signal of the first time, transmits a necessary number of test measurement signals for setting the relay times not set in the first test measurement signal, until the relay times corresponding to all the communication sections are set.

8. The system for analyzing quality of communication sections according to claim 7, wherein each relay device, when receiving the test measurement signal, judges whether the relay device itself should set the relay time in the test measurement signal based on judging information included in the test measurement signal, and
when it is judged that the relay device itself should set the relay time, the relay device sets the relay time in the test measurement signal and transmits it, and when it is judged that the relay device itself should not set the relay time, transmits the test measurement signal without setting the relay time therein.

9. The system for analyzing quality of communication sections according to claim 7, wherein each time the test measurement signal is received, the reception device judges whether the relay time at the relay device located just before the reception device is set or not in the test measurement signal,
when the relay time at the relay device is not set, the reception device creates a test log signal including all the relay times set in the test measurement signal or the transmission time and all the relay times, and transmits the test log signal to the analysis device, and
when the relay time at the relay device is set, the reception device creates a test log signal including all the relay times set in the test measurement signal or the transmission time and all the relay times, and the reception time of the test measurement signal at the reception device, and transmits the test log signal to the analysis device.

10. The system for analyzing quality of communication sections according to claim 9, wherein the calculation unit of the analysis device includes:
a measurement log table creation unit creating, from plural test log signals received by the reception unit corresponding to the test processing performed by the predetermined two or more times, a measurement log table composed of records, each of which includes the transmission times, the relay times, and the reception times;
a fluctuation amount calculation unit calculating a fluctuation amount in each communication section between the transmission device and the reception device based on the transmission times, the relay times, and the reception times in the measurement log table; and
a fluctuation calculation result table creation unit calculating an average value of fluctuation amounts obtained by the fluctuation amount calculation unit, and creating a fluctuation calculation result table composed of records, each of which includes the average value and identification information of the communication section corresponding to the average value.

11. The system for analyzing quality of communication sections according to claim 8, wherein:
the analysis device transmits a test start instruction signal including designation of the reception device to the transmission device; and
the transmission device, when receiving the test start instruction signal, sets a call for transmission/reception of the test measurement signal with the reception device designated by the test start instruction signal and executes the test process by the predetermined two or more times, and when the execution of test process is finished, the transmission device transmits a test end notification signal to the analysis device and releases the call.

12. The system for analyzing quality of communication sections according to claim 11, wherein the analysis device starts reception of the test log signal from the reception device designated by the test start instruction signal when transmitting the test start instruction signal, and finishes the reception of the test log signal when receiving the test end notification signal.

13. A system for analyzing quality of communication sections according to claim 1, wherein:
the relay device further sets identification information of the relay device itself when setting the relay time in the test measurement signal;
the reception unit of the analysis device receives the measurement result of the relay device and the identification information of the relay device; and
the output unit outputs the index value and identification information of the relay devices constituting the communication section corresponding to the index value.

14. The system for analyzing quality of communication sections according to claim 1, wherein:
the transmission device, the relay devices, and the reception device are connected to an IP network;
the transmission device and the reception device are any one of an IP telephone, a VOIP gateway, and a router; and
the relay devices are routers.

15. A device for analyzing quality of communication sections, comprising:
a reception unit receiving two or more test signal transmission time measurement results of a transmission device and two or more test signal reception time measurement results of a reception device each of which is obtained by the reception device when transmission/reception of a test signal to which a transmission time of the transmission device is set, is performed two or more times between the transmission device and the reception device;
a calculation unit calculating a quality index value of a communication section between the transmission device and the reception device based on the two or more test signal transmission time measurement results and the two or more test signal reception time measurement results; and
an output unit outputting the communication quality index value of the communication section.

16. A device for analyzing quality of communication sections, comprising:
a reception unit receiving two or more relay time measurement results of a relay device and two or more test signal reception time measurement results of a reception device each of which is obtained by the reception device when transmission/reception of a test signal to which a relay time of the relay device is set when the test signal passes the relay device, is performed two or more times between a transmission device and the reception device;
a calculation unit calculating a quality index value of a communication section structured by the reception device and a relay device located just before the reception device based on the two or more test signal relay time measurement results and the two or more test signal reception time measurement results; and
an output unit outputting the communication quality index value of the communication section.

17. The device for analyzing quality of communication sections according to claim 16, wherein:
when two or more test signal transmission time measurement results set in the test signal at the transmission device are obtained from the test signals received two or more times by the reception device, the reception unit further receives the two or more transmission time measurement results from the reception device; and
the calculation unit further calculates a quality index value of a communication section between the transmission device and a relay device located just behind the transmission device based on the two or more test signal transmission time measurement results and the two or more test signal relay time measurement results.

18. A device for analyzing quality of communication sections, comprising:
a reception unit receiving two or more transmission time. measurement results of a transmission device and two or more test signal relay time measurement results of a relay device each of which is obtained by a reception device when transmission/reception of a test signal to which a transmission time of the transmission device is set at the transmission device and a relay time of the relay device is set when the test signal passes the relay device, is performed two or more times between a transmission device and the reception device;
a calculation unit calculating a quality index value of a communication section between the transmission device and a relay device located just behind the transmission device, based on the two or more test signal transmission time measurement results and the two or more test signal relay time measurement results; and
an output unit outputting the communication quality index value of the communication section.

19. The device for analyzing quality of communication sections according to claim 18, wherein:
when two or more test signal reception time measurement results set in the test signal at the reception device are obtained from the test signals received two or more times by the reception device, the reception unit further receives the two or more transmission time measurement results from the reception device; and
the calculation unit further calculates a quality index value of a communication section between the reception device and a relay device located just before the reception device, based on the two or more test signal relay time measurement results and the two or more test signal reception time measurement results.

20. The device for analyzing quality of communication sections according to claim 16, wherein:
when two or more relay time measurement results of the test signal set at each of plural relay devices located between the transmission device and the reception device for relaying the test signals are obtained at the reception device from the test signals received two or more times by the reception device, the reception unit receives the two or more relay time measurement results; and
the calculation unit further calculates a quality index value of a communication section between the relay devices based on the two or more test signal relay time measurement results.

21. The device for analyzing quality of communication sections according to claim 15, wherein the calculation unit substitutes a reception time (T1) of a test measurement signal (m-1 (m is an integer)) in the reception device (i (i is an integer)), a transmission time (t1) of the test measurement signal (m-1) in the transmission device (i-1), a reception time (T2) of a next test measurement signal (m) in the reception device (i), and a relay time (t2) of the next test measurement signal (m) in the transmission device (i-1) for the following formula:
(T2−T1−t2+t1)²
to calculate as the index value a fluctuation amount of a section between the transmission device (i-1) and the reception device (i) or a fluctuation amount average value obtained from the fluctuation amounts calculated according to the number of times for performing the relay time measurement at the transmission device (i-1) and the number of times for performing the reception time measurement at the reception device (i).

22. The device for analyzing quality of communication sections according to claim 16, wherein the calculation unit substitutes a reception time (T1) of a test measurement signal (m-1 (m is an integer)) in the reception device (i (i is an integer)), a relay time (t1) of the test measurement signal (m-1) in a relay device (i-1) located just before the reception device (i), a reception time (T2) of a next test measurement signal (m) in the reception device (i), and a relay time (t2) of the next test measurement signal (m) in the relay device (i-1) for the following formula:
(T2−T1−t2+t1)²
to calculate as the index value a fluctuation amount of a section between the relay device (i-1) and the reception device (i), or a fluctuation amount average value obtained from the fluctuation amounts calculated according to the number of times for performing the relay time measurement at the relay device (i-1) and the number of times for performing the reception time measurement at the reception device (i).

23. The device for analyzing quality of communication sections according to claim 18, wherein the calculation unit substitutes a relay time (T1) of a test measurement signal (m-1 (m is an integer)) in the transmission device (i (i is an integer)), a transmission time (t1) of the test measurement signal (m-1) in a transmission device (i-1) located just before the relay device (i), a relay time (T2) of a next test measurement signal (m) in the relay device (i), and a transmission time (t2) of the next test measurement signal (m) in the transmission device (i-1) for the following formula:
(T2−T1−t2+t1)²
to calculate as the index value a fluctuation amount of a section between the transmission device (i-1) and the relay device (i), or a fluctuation amount average value obtained from the fluctuation amounts calculated according to the number of times for performing the transmission time measurement at the transmission device (i-1) and the number of times for performing the relay time measurement at the relay device (i).

24. The device for analyzing quality of communication sections according to claims 15, wherein the calculation unit includes:
a measurement log table creation unit creating from plural test log signals received by the reception unit corresponding to the test processing performed by the predetermined two or more times, a measurement log table composed of records, each of which includes the transmission times, the relay times, and the reception times;
a fluctuation amount calculation unit calculating a fluctuation amount in each communication section between the transmission device and the reception device based on the transmission times, the relay times, and the reception times in the measurement log table; and
a fluctuation calculation result table creation unit calculating an average value of fluctuation amounts obtained by the fluctuation amount calculation unit, and creating a fluctuation calculation result table composed of records, each of which includes the average value and identification information of the communication section corresponding to the average value.

25. The device for analyzing quality of communication sections according to claims 15, further comprising:
a unit transmitting a test start instruction signal including designation of the reception device for instructing a start of transmission/reception of the test measurement signal between the transmission device and the reception device, to the transmission device; and
a unit receiving a test end notification signal transmitted from the transmission device when the test measurement signal transmission processing by predetermined two or more times by the transmission device is finished,
wherein the reception unit receives at least one of the transmission time, the reception time, and the relay time transmitted from the reception device designated by the test start instruction signal from the transmission of the test start instruction signal until the reception of the test end notification signal.

26. The device for analyzing quality of communication sections according to claim 15, wherein:
the reception unit receives identification information of devices that have set the transmission time, the reception time, or the relay time in the test measurement signal together with at least one of measurement results of the transmission time, the reception time, and the relay time; and
the output unit outputs the index value and identification information of devices constituting the communicating section corresponding to the index value.
